(19) United States
(12) Patent Application Publication
(10) Pub. No.: US 2010/0215137 A1
(43) Pub. Date: Aug. 26, 2010

(54) Method and apparatus for producing radioisotope

(76) Inventors: Yasuki Nagai, Ibaraki (JP); Masumi Oshima, Ibaraki (JP); Masashi Hashimoto, Ibaraki (JP); Yuichi Hatsukawa, Ibaraki (JP); Hideo Harada, Ibaraki (JP); Tadahiro Kin, Ibaraki (JP); Osamu Iwamoto, Ibaraki (JP); Nobuyuki Iwamoto, Ibaraki (JP); Mariko Segawa, Ibaraki (JP); Tikara Konno, Ibaraki (JP); Kentaro Ochiai, Ibaraki (JP)

Correspondence Address: WENDEROTH, LIND & PONACK, L.L.P., 1030 15th Street, N.W.,, Suite 400 East, Washington, DC, 20005-1503, US

(21) Appl. No.: 12/656,140

(22) Filed: Jan. 19, 2010

(30) Foreign Application Priority Data
Feb. 24, 2009 (JP) 2009-041572
Feb. 24, 2009 (JP) 2009-041573
Feb. 24, 2009 (JP) 2009-041574
Feb. 24, 2009 (JP) 2009-041576
Feb. 24, 2009 (JP) 2009-041577
Feb. 24, 2009 (JP) 2009-041579
Feb. 24, 2009 (JP) 2009-041580
Sep. 9, 2009 (JP) 2009-208399
Nov. 9, 2009 (JP) 2009-256046
Nov. 27, 2009 (JP) 2009-270457
Jan. 18, 2010 (JP) 2010-008604
Jan. 18, 2010 (JP) 2010-008605
Jan. 18, 2010 (JP) 2010-008606
Jan. 18, 2010 (JP) 2010-008607
Jan. 18, 2010 (JP) 2010-008608

(51) Int. Cl. G21G 1/06

(52) U.S. Cl. 376/158

(57) ABSTRACT

A radioisotope is produced through any of the following reactions using a target material:
(1) (n, 2n) reaction: two-neutron pickup reaction induced by neutrons,
(2) (n, 3n) reaction: three-neutron pickup reaction induced by neutrons,
(3) (n, n′) reaction: neutron inelastic scattering reaction,
(4) (n, p) reaction: one proton-pickup reaction induced by neutrons,
(5) (n, np) reaction: one neutron- and one proton-pickup reaction induced by neutrons,
(6) (n, ⁴He) reaction: one ⁴He-pickup reaction induced by neutrons.

### TECHNICAL FIELD

The present invention relates to a method and an apparatus for enabling stable supply of radioisotopes for use in radioactive diagnostic agents through efficient and inexpensive production thereof not using nuclear fuel material uranium and not generating a large quantity of radioactive waste that comprises various isotopes in a broad range having a high intensity and having a long half-life (for example, from strontium 90 to cesium 137).

### BACKGROUND ART

At present, in the field of medical treatment, radiations and radioisotopes (hereinafter this may be referred to as RI) are indispensable for diagnosis and treatment for diseases. The radiations emitted by RI can be surely detected and quantified even though the amount of the material itself is extremely small; and examination and diagnosis through scintigraphy based on this property are now under way in the art. The medicines used for it are referred to as so-called “radiopharmaceuticals”, and for RIs for use in radiopharmaceuticals and others, those having a short half-life and capable of emitting a gamma ray having a high penetrating power are suitable.

RIs for use in radiopharmaceuticals and the like and their application examples are described. For example, ^{99m}Tc is for brain, thyroid gland and bone scintigraphy; ⁶⁷Ga is for treatment for breast cancer, lung cancer and malignant lymphoma; ²⁰¹Tl is for parathyroid gland, tumor and myocardial scintigraphy; ⁶⁰Co is for radiation source for gamma knife; ³²P is for treatment of leukemia; ³⁵S is for DNA base sequencing and genetic chromosome configuration determination; ⁵¹Cr is for measurement of the amount of circulating blood and the amount of circulating red blood cells; ⁵⁹Fe is for measurement of the total iron binding capability (TIBC) in serum; ⁸⁹Sr, ¹⁵³Sm and ¹⁸⁶Re are for pain relievers: ⁹⁰Y is for treatment for malignant lymphoma; ¹⁰³Pd is for treatment for prostate cancer; ¹²⁵I is for tumor markers; ¹³¹I is for treatment for hyperthyroidism and thyroid cancer; ¹³³Xe is for examination of local lung ventilation function, etc.

At present, ^{99m}Tc, ⁹⁰Y, ¹³¹I and ¹³³Xe of these RIs are produced from a starting material of highly-enriched ²³⁵U prepared by concentrating ²³⁵U by from 36% to 93% or so, by processing the starting material for fission reaction through neutron irradiation in a nuclear reactor, followed by extracting them from the fission product. The method of using enriched ²³⁵U is problematic especially in the viewpoint of nuclear nonproliferation; and the International Atomic Energy Agency (IAEA) and others encourage many countries in the world to change the method into a technique of using low-enriched ²³⁵U having a ²³⁵U concentration degree of at most 20%; and technical development corresponding to it is being promoted in the world. However, despite of the approach continuing for 30 years, almost all RIs in the world are still produced using highly-enriched ²³⁵U. On the other hand, when low-enriched ²³⁵U having a degree of ²³⁵U concentration of at most 20% is used as the starting material for production of RIs, there occurs a new problem in that the amount of plutonium to be produced increased up to about 25 times. Accordingly, a method of irradiating a target with a thermal neutron (0.025 eV) in a nuclear reactor and extracting the produced RI is utilized, like for ⁶⁰Co, ³²P, ³⁵S; ⁵¹_{Cr,} ⁵⁹Fe, ⁸⁹Sr, ¹⁵³Sm and ¹⁸⁶Re.

In addition, a method of irradiating a target with charged particles from a cyclotron is also utilized, like for ⁶⁷Ga, ²⁰¹Tl, ¹⁰³Pd and ¹²⁵I.

RIs are partly produced in Japan; but in fact, most of them are imported from abroad. In 2007, radiopharmaceuticals were difficult to obtain owing to nuclear reactor trouble in Canada, and this brought about a serious problem. In August 2008, a nuclear reactor in the Netherlands, which provided about 26% ⁹⁹Mo in the world market, was stopped owing to partial corrosion deformation of the bottom structure of the primary cooling system therein, and it was re-started in mid-February 2009. However, a nuclear reactor in Canada was again stopped in May 2009 owing to the revelation of heavy water leakage, and its restoration could be at the end of March 2010 at earliest. In that manner, in case where almost all RIs are imported from other countries, it is anticipated that a stable supply system could not be maintained owing to the domestic affairs in other countries or to the aging, maintenance or trouble of nuclear reactors, and stable supply of RIs is an important and urgent issue. In particular, in Canada on which Japan relies as an exporting country for importation of most of RIs, the nuclear reactor for RI supply is expected to reach the operation certification limit in 2011, and after that, there exist no realistic plan at all standing on a worldwide point of view and a long-term point of view. Also in US and Europe, stable supply of RIs such as typically ⁹⁹Mo and others is much needed; however, a realistic system capable of satisfying it could not as yet been made, and it is necessary to establish the system as quickly as possible (Non-Patent Document 1). In case where most of RIs are imported from abroad, the cost of RIs for use in the field of medical treatment or the like may increase, and therefore this may be a major cause of swelling the entire medical expenses. In 2007, the sales price of radiopharmaceuticals reached 44 billion yen (Non-Patent Document 2, page 5).

When ²³⁵U is processed for nuclear fission in a nuclear reactor, other various nuclides than the intended RI are produced as shown in FIG. 1 (Non-Patent Document 3); and the storage, management and processing of the unnecessary nuclear waste products take great labor and are therefore extremely troublesome.

In consideration of the problem, the present applicants have proposed a technique of efficiently producing radioactive molybdenum ⁹⁹Mo, a parent nuclide of radioactive technetium ^{99m}Tc which is used very often as a radioactive diagnostic agent, not using ²³⁵U (Patent Document 1). The proposed method comprises irradiating an aqueous Mo solution prepared by dissolving an Mo compound in water, with neutron in a radiation cap cell disposed in the core of an nuclear reactor to thereby form ⁹⁹Mo through ⁹⁸Mo(n,γ) reaction, followed by continuously or batchwise collecting the aqueous Mo solution to thereby efficiently produce ⁹⁹Mo. Similarly, Patent Document 2 proposes a technique of producing radioactive molybdenum ⁹⁹Mo through thermal neutron capture reaction, using ⁹⁸Mo. However, in the case of employing thermal neutron capture reaction, the production site is limited since an nuclear reactor is used, and moreover, the method greatly depends on the operation mode of the nuclear reactor and the production cost is high, and the specific activity is low since the reaction cross-section is small, and the production efficiency is problematic. Regarding the maintenance of the nuclear reactor, for example, a situation may occur that the reactor must be stopped for a half year for periodic inspections or the like, in consideration of the safety thereof, etc. From these situations, further technical measures must be tried and made for simple and stable supply of ⁹⁹Mo in facilities such as hospitals, etc.

On the other hand, also carried out is RI production by irradiating a target material with proton or heavy ion beams from an accelerator. With proton, the accelerator to be used may be compact and may be used in facilities such as hospitals or the like in a simplified manner. However, in case where RI is produced by the use of proton to be emitted by such a compact accelerator, the method is applicable to only RIs of lightweight nuclides; and when the method is applied to RIs of heavyweight nuclides, there is a problem in that the accelerator must be inevitably large-sized. Specifically, in case where RI is produced with proton, the proton has a positive charge; and therefore, in order that the proton may react with the target nucleus of a heavyweight nuclide (this is an atomic nucleus having many positively-charged protons), the proton must get into in the inside of the atomic nucleus, after overcoming the repulsive interaction between the positive charges. For this, the energy of the incident proton must be sufficiently high. Further, when a proton has come in a target substance, the energy of the proton greatly reduces in the target, and therefore, the thickness of the usable target is limited, consequently resulting in that the efficiency in producing satisfactory RIs may be not high in many cases. On the other hand, the energy loss in the target results in elevation in the target temperature, and therefore, the applicable intensity of the proton beam to a target not having a high melting point may be limited. A proton beam is produced in an accelerator and is transported through a vacuum pipe near to the site where a target is set. In that situation, when a target is set on the side of air, the vacuum condition in the vacuum pipe must be kept and must be shut off from the air side part. For suppressing the energy and the intensity of the proton beam, the substance to be used for shutting off must be as thin as possible. On the other hand, however, where the substance is all the time kept in continuous exposure to proton beams, and as a result, it may be broken by radiation damage, and it is difficult to continuously use high-intensity proton beams for a long period of time. For producing different types of RIs in accordance with the object thereof, when a target substance can be set in air, then the shape and the material of the target may be flexibly selected, which will be extremely convenient in practical use. However, as described above, RI production with proton beams has problems. The situations are similar to the case with heavy ion beams. The problem with heavy ion beams may be more serious since the heavy ion has more positive charges than proton.

### Prior Art Documents

Patent Documents

Patent Document 1: JP-A 2008-102078

Patent Document 2: JP-T 2002-504231

Non-Patent Documents

Non-Patent Document 1: “Accelerating production of medical isotopes”, Nature, Vol. 457, 29 Jan. 2009

Non-Patent Document 2: Science Council of Japan, Basic Medicine Commission/Applied Science and Technology Jointed, Section Meeting for Investigation of Problems with Utilization of Radioactivity/Radiation, “Proposal: Regarding safe supply system for radioisotopes in Japan”, Jul. 24, 2008

Non-Patent Document 3: Nuclear Physics, A462 (1987) 85-108, North-Holland, Amsterdam

### DISCLOSURE OF THE INVENTION

It is an object of the present invention to solve the above-mentioned prior-art problems and to provide a method and an apparatus capable of realizing stable supply of radioisotopes efficiently, inexpensively and in a simplified manner, not using concentrated ²³⁵U, not utilizing a nuclear reactor facility, and not generating a large quantity of radioactive waste.

For solving the above-mentioned problems, the invention provides a technical method and means mentioned below.

[1] A method for producing a radioisotope by irradiating a target material with fast neutrons from an accelerator.

[2] The method for producing a radioisotope of the above first invention, wherein a target material is irradiated with fast neutrons from an accelerator to produce a radioisotope by emitting non-charged particles.

[3] The method for producing a radioisotope of the above second invention, wherein any of the following reactions is used to produce a radioisotope:
(1) (n, 2n) reaction: two-neutron pickup reaction induced by neutrons,
(2) (n, 3n) reaction: three-neutron pickup reaction induced by neutrons,
(3) (n, n′) reaction: neutron inelastic scattering reaction.

[4] The method for producing a radioisotope of the above third invention, wherein one or several targets listed in Table 1 to Table 8 can be used to produce a radioisotope by the (n, 2n) reaction.

[5] The method for producing a radioisotope of the above third invention, wherein one or several targets listed in Table 9 can be used to produce a radioisotope by the (n, 3n) reaction.

[6] The method for producing a radioisotope of the above third invention, wherein one or several targets listed in Table 10 and Table 11 can be used to produce a radioisotope by the (n, n′) reaction.

[7] The method for producing a radioisotope of the above first invention, wherein a target material is irradiated with fast neutrons from an accelerator to produce a radioisotope by emitting charged particles or charged particles and non-charged particles.

[8] The method for producing a radioisotope by the above seventh invention, wherein any of the following reactions is used to produce a radioisotope:
(1) (n, p) reaction: one proton-pickup reaction induced by neutrons,
(2) (n, np) reaction: one neutron- and one proton-pickup reaction induced by neutrons,
(3) (n, ⁴He) reaction: one ⁴He-pickup reaction induced by neutrons.

[9] The method for producing a radioisotope of the above eighth invention, wherein one or several targets listed in Table 12 to Table 18 can be used to produce a radioisotope by the (n, p) reaction.

[10] The method for producing a radioisotope of the above eighth invention, wherein one or several targets listed in Table 19 and Table 20 can be used to produce a radioisotope by the (n, np) reaction.

[11] The method for producing a radioisotope of the above eighth invention, wherein one or several targets listed in Table 21 can be used to produce a radioisotope by the (n, ⁴He) reaction.

[12] The method for producing a radioisotope of the above first invention, wherein a target material is set either very close or near to the fast neutron production position.

[13] An apparatus for producing a radioisotope, comprising:

an accelerator for producing fast neutrons, and

a target support;

wherein a target material is irradiated with fast neutrons from an accelerator to produce a radioisotope.

[14] The apparatus for producing a radioisotope of the above thirteenth invention, wherein a target material is irradiated with fast neutrons from an accelerator to produce a radioisotope by emitting non-charged particles.

[15] The apparatus for producing a radioisotope of the above fourteenth invention, wherein any of the following reactions is used to produce a radioisotope:
(1) (n, 2n) reaction: two-neutron pickup reaction induced by neutrons,
(2) (n, 3n) reaction: three-neutron pickup reaction induced by neutrons,
(3) (n, n′) reaction: neutron inelastic scattering reaction.

[16] The apparatus for producing a radioisotope of the above fifteenth invention, wherein one or several targets listed in Table 1 to Table 8 can be used to produce a radioisotope by the (n, 2n) reaction.

[17] The apparatus for producing a radioisotope of the above fifteenth invention, wherein one or several targets listed in Table 9 can be used to produce a radioisotope by the (n,3n) reaction.

[18] The apparatus for producing a radioisotope of the above fifteenth invention, wherein one or several targets listed in Table 10 and Table 11 can be used to produce a radioisotope by the (n, n′) reaction.

[19] The apparatus for producing a radioisotope of the above thirteenth invention, wherein a target material is irradiated with fast neutrons from an accelerator to produce a radioisotope by simultaneously emitting charged particles or charged particles and non-charged particles.

[20] The apparatus for producing a radioisotope of the above nineteenth invention, wherein any of the following reactions is used to produce a radioisotope:
(1) (n, p) reaction: one proton-pickup reaction induced by neutrons,
(2) (n, np) reaction: one neutron- and one proton-pickup reaction induced by neutrons,
(3) (n, ⁴He) reaction: one ⁴He-pickup reaction induced by neutrons.

[21] The apparatus for producing a radioisotope of the above twentieth invention, wherein one or several targets listed in Table 12 to Table 18 can be used to produce a radioisotope by the (n, p) reaction.

[22] The apparatus for producing a radioisotope of the above twentieth invention, wherein one and/or several targets listed in Table 19 and Table 20 can be used to produce a radioisotope by the (n, np) reaction.

[23] The apparatus for producing a radioisotope of the above twentieth invention, wherein one or several targets listed in Table 21 can be used to produce a radioisotope by the (n, ⁴He) reaction.

[24] The apparatus for producing a radioisotope of the above thirteenth invention, wherein a target material is set either very close or near the fast neutron production position.

[25] The apparatus for producing a radioisotope of the above thirteenth invention, wherein fast neutrons are produced in a vacuum chamber and the fast neutron production place can be cooled by using any coolant, and a target material is set either very close or near to the fast neutron production position.

According to the invention, a target material is irradiated with fast neutron from an accelerator to induce the above-mentioned various reaction thereby producing RI, and the invention enables stable supply of RIs efficiently and inexpensively with reducing radioactive waste having a high intensity and a long half-life period, not using concentrated ²³⁵U and not utilizing a nuclear reactor facility.

The RI producing apparatus of the invention is not subject to regulation of nuclear fuel substances, and can be compact, therefore having the advantage of using it in facilities such as hospitals and others in a simplified manner.

Further, according to the invention, RI is produced through irradiation of a target material with neutron having no electric charge; and therefore, as compared with a case of irradiating a target with positively-charged proton beams, the invention has the following advantages: A small-size accelerator can be used for heavy target nuclides like that for light target nuclides. In addition, the invention is free from troubles of energy loss owing to the electromagnetic interaction inside the target and the resulting heat generation by the target; and as compared with a case with proton beams, a target having a higher weight by at least about 100 times or so can be irradiated all at once, and the amount of RI to be produced can be increased. Further, since the target can be set in air, there is another advantage in that the latitude in target disposition and in material selection is broad. Accordingly, it is believed that the invention provides immeasurable convenience to various users.

### BRIEF DESCRIPTION OF THE DRAWINGS

FIG. 1 is a view showing the yield distribution of nuclides produced in nuclear fission of ²³⁵U in a nuclear reactor.

FIG. 2 is a graph showing the evaluated reaction cross-section between a target material having ¹⁰⁰Mo as the target nucleus and fast neutron in irradiation of the target material with fast neutron.

FIG. 3 is a graph showing the evaluated reaction cross-section between a target material having ¹⁴⁸Nd as the target nucleus and fast neutron in irradiation of the target material with fast neutron.

FIG. 4 is a view showing the relationship between fast neutron and the reaction cross-section of ¹⁰⁰Mo in irradiation of ¹⁰⁰Mo with fast neutron to induce (n, 2n) reaction thereby producing ⁹⁹Mo.

FIG. 5 is a view showing the neutron energy and the evaluated reaction cross-section in irradiation of a target material having ¹²⁷I as the target nucleus with fast neutron.

FIG. 6 is a view showing the neutron energy and the evaluated reaction cross-section in irradiation of a target material having ¹¹⁷Sn as the target nucleus with fast neutron.

FIG. 7 is a view showing the neutron energy and the evaluated reaction cross-section in irradiation of a target material having ⁵⁹Co as the target nucleus with fast neutron.

FIG. 8 is a view showing the neutron energy and the evaluated reaction cross-section in irradiation of a target material having ⁵⁸Ni as the target nucleus with fast neutron.

FIG. 9 is a view showing the neutron energy and the evaluated reaction cross-section in irradiation of a target material having ⁴⁵Sc as the target nucleus with fast neutron.

FIG. 10 schematically shows an RI production apparatus of one embodiment of the invention.

FIG. 11 shows a sample container for use in a case where RI to be produced is a gas.

FIG. 12 schematically shows the substantial parts of an RI production apparatus of another embodiment of the invention.

FIG. 13 is a flowchart showing one example of the RI production method of the invention.

FIG. 14 shows the measurement data of the gamma ray emitted in beta decay of produced ⁹⁹Mo.

FIG. 15 shows the results in measured intensity change of the gamma ray emitted from ^{99m}Tc, for which fast neutron-irradiated molybdenum-mixed titanic acid gel was put in a glass tube, subjected to milking with water or physiological saline, and the resulting liquid was dried.

FIG. 16 shows the results in measured intensity change of the gamma ray emitted from ^{99m}Tc, for which fast neutron-irradiated molybdenum-mixed titanic acid gel was put in a beaker, milked with water or physiological saline, and the resulting liquid was dried.

FIG. 17 is a view showing a measurement data of 811 keV gamma ray emitted from ⁵⁸Co in beta decay thereof produced by irradiating the target material including ⁵⁹Co as target nucleus with fast neutron from an accelerator.

FIG. 18 is a view for collateral evidence for RI production through (n, 3n) reaction, from the result of detection of 935 keV gamma ray emitted in beta decay of ⁹²Nb, in measurement of the ⁹³Nb target in Example 1.

FIG. 19 is a view showing the evaluated values of various reactions occurring in irradiation of ⁹³Nb target with neutron, and the neutron energy dependence of the cross-section thereof.

FIG. 20 shows the result of detection in measurement of 1099 keV and 1291 keV gamma ray emitted in beta decay of produced ⁵⁹Fe, using a Ge semiconductor detector.

FIG. 21 is a view showing the result of detection in measurement of 766 keV gamma ray emitted in beta decay of produced ⁹⁹Mo, using a Ge semiconductor detector.

FIG. 22 is a view showing the result of detection in measurement of 739 keV gamma ray emitted in beta decay of produced ⁹⁹Mo, using a Ge semiconductor detector.

FIG. 23 is a view showing the result of detection in measurement of 233 keV gamma ray emitted in decay from the 233 keV excited state of ¹³³Xe to the ground state thereof, using a Ge semiconductor detector.

FIG. 24 is a view showing the evaluated value of the neutron energy dependency of the cross-section of the (n, p) reaction occurring in irradiation of ¹³³Cs target with neutron.

FIG. 25 is a view for collateral evidence for production of RI ¹³³Xe in reaction of ¹³⁴Xe (n, 2n) ¹³³Xe, using a gaseous target material ¹³⁴Xe.

### PREFERRED EMBODIMENTS OF THE INVENTION

The invention is described in detail hereinunder with reference to embodiments thereof.

In the invention, a radioisotope for use in radioactive diagnostic agents and others is produced by irradiating a target material with fast neutron from an accelerator. In the invention, the fast neutron means a neutron having energy of not lower than 0.1 MeV.

A one aspect of the invention, a target material is irradiated with fast neutron from an accelerator to emit non-charged particles, thereby producing a radioisotope.

In this case, any of the following reactions is induced depending on the type of the target material to produce a radioisotope directly or through beta decay:

(1) (n, 2n) reaction: two-neutron pickup reaction induced by neutrons.

(2) (n, 3n) reaction: three-neutron pickup reaction induced by neutrons.

(3) (n, n′) reaction: neutron inelastic scattering reaction.

Another aspect of the invention, a target material is irradiated with fast neutron from an accelerator to emit charged particles or charged particles and non-charged particles, thereby producing a radioisotope.

In this case, any of the following reactions is induced depending on the type of the target material to produce a radioisotope directly or through beta decay:

(4) (n, p) reaction: one proton-pickup reaction induced by neutrons.

(5) (n, np) reaction: one neutron- and one proton-pickup reaction induced by neutrons.

(6) (n, ⁴He) reaction: one ⁴He-pickup reaction induced by neutrons.

Irradiation of a target material with fast neutron induces various reactions such as (n, 2n) reaction, (n, 3n) reaction, (n, n′) reaction, (n, p) reaction, (n, np) reaction, (n, ⁴He) reaction, etc. It has been confirmed that the reaction cross-section in the reaction to occur with the target material to which the invention is directed, depending on the type of the target material, is extremely large, and, according to the invention, radioisotope can be produced efficiently as comparable to radioisotope production in a nuclear reactor. According to the invention, the intended radioisotope can be produced not releasing a large quantity of radioactive waste like in the case of using a nuclear reactor and reducing the radioactivity of the waste.

The individual reactions in the invention are described in detail.

### <1> (n, 2n) Reaction:

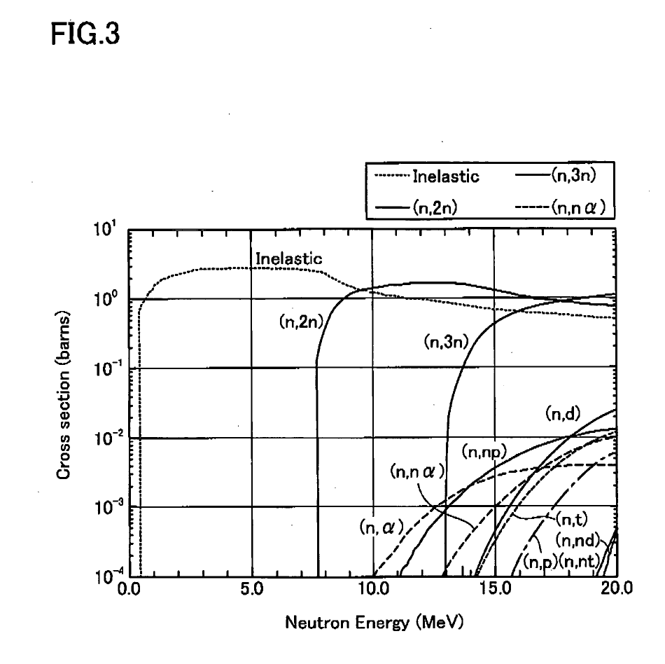

FIG. 2 and FIG. 3 each show a graph of the neutron energy and the evaluated reaction cross-section in irradiation of a target material having ¹⁰⁰Mo or ¹⁴⁸Nd as the target nucleus, as an example having a large reaction cross-section of (n, 2n) reaction, with fast neutron.

From FIG. 2 and FIG. 3, it is known that, when the target material is irradiated with fast neutron, the (n, 2n) evaluated reaction cross-section is near to a maximum value and is extremely larger than the cross-section of other reactions, depending on the value of the neutron energy.

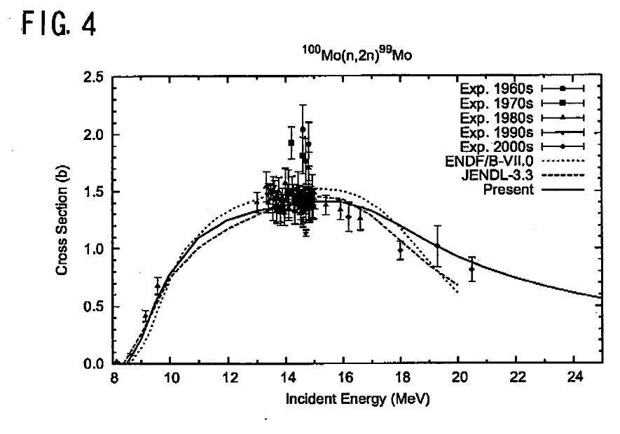

FIG. 4 shows a relationship between the fast neutron and the ¹⁰⁰Mo reaction cross-section in irradiation of ¹⁰⁰Mo with fast neutron to induce (n, 2n) reaction to produce ⁹⁹Mo. From FIG. 4, it is known that the (n, 2n) reaction rapidly rises at around the neutron energy of 8.5 MeV or so, and has an extremely large and almost constant reaction cross-section at from around 9.5 MeV to around 25 MeV. It is also known that the (n, 2n) reaction cross-section has a value near to a maximum value at around 14 MeV.

In the invention, a target nucleus in Table 1 to Table 8 below is used, and a radioisotope (product nucleus) is produced in (n, 2n) reaction directly or through beta decay. Examples of targets to be used are also shown in Table 1 to Table 7. Examples of gas target materials are shown in Table 8 below.

TABLE 1

| Product Nucleus | Target Nucleus | Examples of Target |
|---|---|---|
| ²²Na | ²³Na | NaCl, Na₂Cl₃ |
| ⁴⁷Ca | ⁴⁸Ca | CaCO₃ |
| ⁴⁴Sc | ⁴⁵Sc | Sc₂O₃ |
| ⁴⁷Sc | ⁴⁸Ca | CaCO₃ |
| ⁴⁵Ti | ⁴⁶Ti | TiO₂ |
| ⁴⁹V | ⁵⁰V, ⁵⁰Cr | VO₂,CrO₂ |
| ⁵¹Cr | ⁵²Cr | CrO₂ |
| ⁵⁴Mn | ⁵⁵Mn | MnO₂ Mn metal foil |
| ⁵⁵Fe | ⁵⁶Fe | Fe₂O₃ |
| ⁵⁷Co | ⁵⁸Ni | NiO |
| ⁵⁸Co | ⁵⁹Co | CoO |
| ⁵⁷Ni | ⁵⁸Ni | NiO |
| ⁶³Ni | ⁶⁴Ni | NiO |
| ⁶⁴Cu | ⁶⁵Cu | CuO |
| ⁶³Zn | ⁶⁴Zn | ZnO |
| ⁶⁵Zn | ⁶⁶Zn | ZnO |
| ⁶⁹Zn | ⁷⁰Zn | ZnO |
| ⁶⁸Ga | ⁶⁹Ga | Ga₂O₃ |
| ⁷⁰Ga | ⁷¹Ga | Ga₂O₃ |
| ⁶⁹Ge | ⁷⁰Ge | GeO₂ |

TABLE 2

| Product Nucleus | Target Nucleus | Examples of Target |
|---|---|---|
| ⁷¹Ge | ⁷²Ge | GeO₂ |
| ⁷⁵Ge | ⁷⁶Ge | GeO₂ |
| ⁷⁴As | ⁷⁵As | As₂O₃ |
| ⁷³Se | ⁷⁴Se | SeO₂ |
| ⁷⁵Se | ⁷⁶Se | SeO₂ |
| ⁸¹Se | ⁸²Se | SeO₂ |
| ⁸⁰Br | ⁸¹Br | BrO₂ |
| ⁸³Rb | ⁸⁴Sr | SrO |
| ⁸⁴Rb | ⁸⁵Rb | Rb₂CO₃ |
| ⁸³Sr | ⁸⁴Sr | SrO |
| ⁸⁸Y | ⁸⁹Y | Y₂O₃ |
| ⁸⁹Zr | ⁹⁰Zr | ZrO₂ |
| ⁹⁵Zr | ⁹⁶Zr | ZrO₂ |
| ⁹¹Nb | ⁹²Mo | MoO₃ |
| ⁹²Nb | ⁹³Nb | Nb₂O₅ |
| ⁹⁹Mo | ¹⁰⁰Mo | MoO₃ |
| ⁹⁵Tc | ⁹⁶Ru | RuO₂ |
| ⁹⁷Tc | ⁹⁸Ru | RuO₂ |
| ⁹⁵Ru | ⁹⁶Ru | RuO₂ |
| ⁹⁷Ru | ⁹⁸Ru | RuO₂ |
| ¹⁰³Ru | ¹⁰⁴Ru | RuO₂ |

TABLE 3

| Product Nucleus | Target Nucleus | Examples of Target |
|---|---|---|
| ¹⁰¹Rh | ¹⁰²Pd | PdO |
| ¹⁰²Rh | ¹⁰³Rh | Rh₂O₃ |
| ¹⁰¹Pd | ¹⁰²Pd | PdO |
| ¹⁰³Pd | ¹⁰⁴Pd | PdO |
| ¹⁰⁹Pd | ¹¹⁰Pd | PdO |
| ¹⁰⁵Ag | ¹⁰⁶Cd | CdO |
| ¹⁰⁶Ag | ¹⁰⁷Ag | Ag₂O |
| ¹⁰⁸Ag | ¹⁰⁹Ag | Ag₂O |
| ¹⁰⁵Cd | ¹⁰⁶Cd | CdO |
| ¹⁰⁷Cd | ¹⁰⁸Cd | CdO |
| ¹⁰⁹Cd | ¹¹⁰Cd | CdO |
| ¹¹⁵Cd | ¹¹⁶Cd | CdO |
| ¹¹¹In | ¹¹²Sn | SnO |
| ¹¹²In | ¹¹³In | In₂O₃ |
| ¹¹⁴In | ¹¹⁵In | In₂O₃ |
| ¹¹¹Sn | ¹¹²Sn | SnO |
| ¹¹³Sn | ¹¹⁴Sn | SnO |
| ^{117m}Sn | ¹¹⁸Sn | SnO |
| ^{119m}Sn | ¹²⁰Sn | SnO |
| ¹²¹Sn | ¹²²Sn | SnO |
| ¹²³Sn | ¹²⁴Sn | SnO |

TABLE 4

| Product Nucleus | Target Nucleus | Examples of Target |
|---|---|---|
| ¹¹⁹Sb | ¹²⁰Te | TeO₂ |
| ¹²⁰Sb | ¹²¹Sb | Sb₂O₃ |
| ¹²²Sb | ¹²³Sb | Sb₂O₃ |
| ¹¹⁹Te | ¹²⁰Te | TeO₂ |
| ¹²¹Te | ¹²²Te | TeO₂ |
| ¹²⁷Te | ¹²⁸Te | TeO₂ |
| ¹²⁹Te | ¹³⁰Te | TeO₂ |
| ¹²⁶I | ¹²⁷I | NaI |
| ¹²⁹Cs | ¹³⁰Ba | BaO |
| ¹³¹Cs | ¹³²Ba | Ba0 |
| ¹³²Cs | ¹³³Cs | Cs₂O₃ |
| ¹²⁹Ba | ¹³⁰Ba | Ba0 |
| ¹³¹Ba | ¹³²Ba | Ba0 |
| ¹³³Ba | ¹³⁴Ba | Ba0 |
| ¹³⁵La | ¹³⁶Ce | CeO₂ |

TABLE 5

| Product Nucleus | Target Nucleus | Examples of Target |
|---|---|---|
| ¹³⁵Ce | ¹³⁶Ce | CeO₂ |
| ¹³⁷Ce | ¹³⁸Ce | CeO₂ |
| ¹³⁹Ce | ¹⁴⁰Ce | CeO₂ |
| ¹⁴¹Ce | ¹⁴²Ce | CeO₂ |
| ¹⁴¹Nd | 142Nd | Nd₂O₃ |
| ¹⁴⁷Nd | ¹⁴⁸Nd | Nd₂O₃ |
| ¹⁴⁹Nd | ¹⁵⁰Nd | Nd₂O₃ |
| ¹⁴³Pm | ¹⁴⁴Sm | Sm₂O₃ |
| ¹⁴⁷Pm | ¹⁴⁸Nd | Nd₂O₃ |
| ¹⁴⁹Pm | ¹⁵⁰Nd | Nd₂O₃ |
| ¹⁵¹Sm | ¹⁵²Sm | Sm₂O₃ |
| ¹⁵³Sm | ¹⁵⁴Sm | Sm₂O₃ |
| ¹⁵⁰Eu | ¹⁵¹Eu | Eu₂O₃ |
| ¹⁵²Eu | ¹⁵³Eu | Eu₂O₃ |
| ¹⁵¹Gd | ¹⁵²Gd | Gd₂O₃ |
| ¹⁵³Gd | ¹⁵⁴Gd | Gd₂O₃ |
| ¹⁵⁹Gd | ¹⁶⁰Gd | Gd₂O₃ |
| ¹⁵⁵Tb | ¹⁵⁶Dy | Dy₂O₃ |
| ¹⁵⁷Tb | ¹⁵⁸Dy | Dy₂O₃ |
| ¹⁵⁸Tb | ¹⁵⁹Tb | Tb₂O₃ |
| ¹⁵⁵Dy | ¹⁵⁶Dy | Dy₂O₃ |

TABLE 6

| Product Nucleus | Target Nucleus | Examples of Target |
|---|---|---|
| ¹⁵⁷Dy | ¹⁵⁸Dy | Dy₂O₃ |
| ¹⁵⁹Dy | ¹⁶⁰Dy | Dy₂O₃ |
| ¹⁶¹Ho | ¹⁶²Er | Er₂O₃ |
| ¹⁶⁴Ho | ¹⁶⁵Ho | Ho₂O₃ |
| ¹⁶¹Er | ¹⁶²Er | Er₂O₃ |
| ¹⁶³Er | ¹⁶⁴Er | Er₂O₃ |
| ¹⁶⁵Er | ¹⁶⁶Er | Er₂O₃ |
| ¹⁶⁹Er | ¹⁷⁰Er | Er₂O₃ |
| ¹⁶⁷Tm | ¹⁶⁸Yb | Yb₂O₃ |
| ¹⁶⁹Yb | ¹⁷⁰Yb | Yb₂O₃ |
| ¹⁷⁵Yb | ¹⁷⁶Yb | Yb₂O₃ |
| ¹⁷⁴Lu | ¹⁷⁵Lu | Lu₂O₃ |
| ¹⁷³Hf | ¹⁷⁴Hf | Hf₂O₃ |
| ¹⁷⁵Hf | ¹⁷⁶Hf | Hf₂O₃ |
| ¹⁷⁹Ta | ¹⁸⁰W | WO₃ |
| ¹⁷⁹W | ¹⁸⁰W | WO₃ |
| ¹⁸¹W | ¹⁸²W | WO₃ |
| ¹⁸⁵W | ¹⁸⁶W | WO₃ |
| ¹⁸³Re | ¹⁸⁴Os | OsO₂ |
| ¹⁸⁴Re | ¹⁸⁵Re | ReO₂ |
| ¹⁸⁶Re | ¹⁸⁷Re | ReO₂ |
| ¹⁸³Os | ¹⁸⁴Os | OsO₂ |
| ¹⁸⁵Os | ¹⁸⁶Os | OsO₂ |
| ¹⁸⁹Ir | ¹⁹⁰Pt | PtCl₂ |
| ¹⁹⁰Ir | ¹⁹¹Ir | IrO₂ |
| ¹⁹²Ir | ¹⁹³Ir | IrO₂ |
| ¹⁸⁹Pt | ¹⁹⁰Pt | PtCl₂ |
| ¹⁹¹Pt | ¹⁹²Pt | PtCl₂ |
| ¹⁹³Pt | ¹⁹⁴Pt | PtCl₂ |

TABLE 7

| Product Nucleus | Target Nucleus | Examples of Target |
|---|---|---|
| ¹⁹⁷Pt | ¹⁹⁸Pt | PtCl₂ |
| ¹⁹⁵Au | ¹⁹⁶Hg | HgCl₂ |
| ¹⁹⁶Au | ¹⁹⁷Au | HAuCl₄ |
| ¹⁹⁵Hg | ¹⁹⁶Hg | HgO |
| ¹⁹⁷Hg | ¹⁹⁸Hg | HgO |
| ²⁰³Hg | ²⁰⁴Hg | HgO |
| ²⁰²Tl | ²⁰³Tl | TlO₂ |
| ²⁰⁴Tl | ²⁰⁵Tl | TlO₂ |
| ²⁰³Pb | ²⁰⁴Pb | PbCl₂ |

TABLE 8

| | Product Nucleus | Target Nucleus |
|---|---|---|
| 1 | ³⁷Ar | ³⁸Ar |
| 2 | ³⁹Ar | ⁴⁰Ar |
| 3 | ⁷⁷Kr | ⁷⁸Kr |
| 4 | ⁷⁹Kr | ⁸⁰Kr |
| 5 | ⁸⁵Kr | ⁸⁶Kr |
| 6 | ¹²³Xe | ¹²⁴Xe |
| 7 | ¹²⁵Xe | ¹²⁶Xe |
| 8 | ¹²⁷Xe | ¹²⁸Xe |
| 9 | ¹³³Xe | ¹³⁴Xe |
| 10 | ¹³⁵Xe | ¹³⁶Xe |
| 11 | ¹²³I | ¹²⁴Xe |
| 12 | ¹²⁵I | ¹²⁶Xe |

Of the above, ⁴⁷Sc, ⁴⁹V (target nucleus, ⁵⁰Cr), ⁵⁷Co, ⁸³Rb, ⁹¹Nb, ¹⁰¹Rh, ¹⁰⁵Ag, ¹¹¹In, ¹²⁹Cs, ¹³¹Cs, ¹³⁵La, ¹⁴³Pm, ¹⁴⁷Pm, ¹⁴⁹Pm, ¹⁵⁵Tb, ¹⁵⁷Tb, ¹⁶⁷Tm, ¹⁶¹Ho, ¹⁷⁹Ta, ¹⁹⁵Au are obtained through beta decay, and can be carrier-free.

The energy of the fast neutron to be used is described. Here, the energy of the fast neutron for irradiation is within a range between a lowermost limit and a highest limit, in which the lowermost limit is a value computed by adding 0.5 to the threshold energy of (n, 2n) reaction [unit: MeV], and the highest limit is an energy with which the cross-section of the (n, 2n) reaction at the energy is equal to the cross-section of the (n, 2n) reaction at the lowermost limit.

### <2> (n, 3n) Reaction:

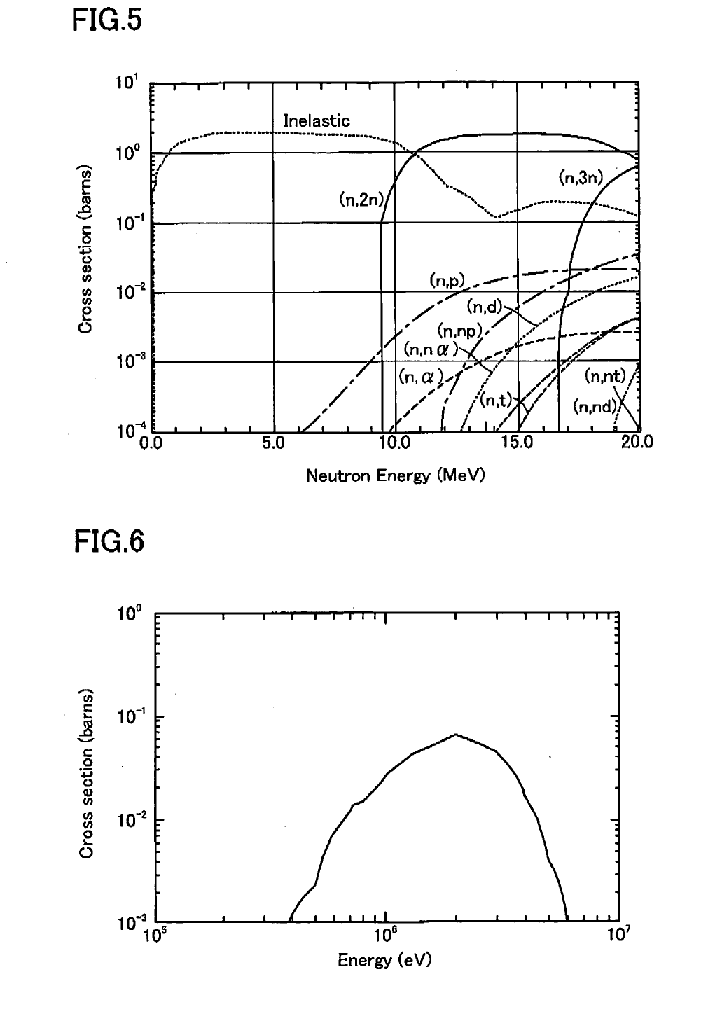

FIG. 5 shows a graph of the neutron energy and the evaluated reaction cross-sections in irradiation of a target material having ¹²⁷I as the target nucleus with fast neutron. From FIG. 5, it is known that, when the target material is irradiated with fast neutron, the (n, 3n) reaction is predominant depending on the neutron energy value, and has an extremely large reaction cross-section.

In the invention, a target nucleus in Table 9 below is used, and a radioisotope (product nucleus) is produced in (n, 3n) reaction directly or through beta decay. Examples of target material to be used are also shown in Table 9.

TABLE 9

| | Product Nucleus | Target Nucleus | Examples of Target |
|---|---|---|---|
| 1 | ¹⁶⁹Yb | ¹⁷¹Yb | Ytterbium Oxide (Yb₂O₃) |
| 2 | ⁶⁷Ga | ⁶⁹Ga | Gallium Oxide (Ga₂O₃) |
| 3 | ⁶⁸Ga | ⁷⁰Ge | Germanium Oxide (GeO₂) |
| 4 | ⁷³As | ⁷⁵As | Arsenic Oxide (As₂O₃) |
| 5 | ⁷⁷Br | ⁷⁹Br | Boron Oxide (BrO₂) |
| 6 | ⁸²Sr | ⁸⁴Sr | Strontium Oxide (SrO) |
| 7 | ⁸⁷Y | ⁸⁹Y | Yttrium Oxide (Y₂O₃) |
| 8 | ⁹¹Nb | ⁹³Nb | Niobium Oxide (NbO) |
| 9 | ¹⁰¹Rh | ¹⁰³Rh | Rhodium Oxide (Rh₂O₃) |
| 10 | ¹⁰⁵Ag | ¹⁰⁷Ag | Silver Oxide (Ag₂O) |
| 11 | ¹¹¹In | ¹¹³In | Indium Oxide (In₂O₃) |
| 12 | ¹¹⁹Sb | ¹²¹Sb | Antimony Oxide (Sb₂O₃) |
| 13 | ¹²⁵I | ¹²⁷I | Sodium Iodide (NaI) |
| 14 | ¹³¹Cs | ¹³³Cs | Cesium Carbonate (Cs₂CO₃) |
| 15 | ¹³⁹Ce | ¹⁴¹Pr | Praseodymium Oxide (Pr₂O₃) |
| 16 | ¹³⁹Pr | ¹⁴¹Pr | Praseodymium Oxide (Pr₂O₃) |
| 17 | ¹⁴⁰Pr | ¹⁴²Nd | Neodymium Oxide (Nd₂O₃) |
| 18 | ¹⁴⁵Sm | ¹⁴⁷Sm | Samarium Oxide (Sm₂O₃) |
| 19 | ¹⁴⁹Eu | ¹⁵¹Eu | Europium Oxide (Eu₂O₃) |
| 20 | ¹⁵⁷Tb | ¹⁵⁹Tb | Terbium Oxide (Tb₂O₃) |
| 21 | ¹⁶⁰Ho | ¹⁶²Er | Erbium Oxide (Er₂O₃) |
| 22 | ¹⁶⁰Er | ¹⁶²Er | Erbium Oxide (Er₂O₃) |
| 23 | ¹⁶⁶Tm | ¹⁶⁸Yb | Ytterbium Oxide (Yb₂O₃) |
| 24 | ¹⁷⁸Ta | ¹⁸⁰W | Tungsten Oxide (WO₃) |
| 25 | ¹⁷⁹Ta | ¹⁸¹Ta | Tantalum Oxide (Ta₂O₃) |
| 26 | ¹⁸³Re | ¹⁸⁵Re | Rhenium Oxide (ReO₂) |
| 27 | ¹⁸⁹Ir | ¹⁹¹Ir | Iridium Oxide (IrO₂) |
| 28 | ¹⁹⁵Au | ¹⁹⁷Au | Gold Chloride (HAuCl₄) |
| 29 | ²⁰¹Tl | ²⁰³Tl | Thorium Oxide (TlO₂) |
| 30 | ²⁰²Tl | ²⁰⁴Pb | Lead Chloride (PbCl₂) |
| 31 | ²⁰²Pb | ²⁰⁴Pb | Lead Chloride (PbCl₂) |

Of the above, the product nuclei, ⁶⁸Ga, ¹³⁹Ce, ¹⁴⁰Pr, ¹⁶⁰Ho, ¹⁶⁶Tm, ¹⁷⁸Ta and ²⁰²Tl are obtained through beta decay, and can be carrier-free.

The energy of the fast neutron to be used is described. Here, the energy of the fast neutron for irradiation of the target nucleus is within a range between a lowermost limit and a highest limit, in which the lowermost limit is a value computed by adding 0.5 MeV to the threshold energy of (n, 3n) reaction, and the highest limit is an energy with which the cross-section of the (n, 3n) reaction at the energy value is equal to the cross-section of the (n, 3n) reaction at the lowermost limit.

<3> (n, n′) Reaction:

FIG. 6 shows a graph of the neutron energy and the evaluated reaction cross-section in irradiation of a target material having ¹¹⁷Sn as the target nucleus with fast neutron, as an example of (n, n′) reaction. From FIG. 6, it is known that, when the target material is irradiated with fast neutron, the (n, n′) reaction is predominant depending on the neutron energy, and has a large reaction cross-section.

Here, a target nucleus in Table 10 below is used, and a radioisotope (product nucleus) is produced through (n, n′) reaction. Examples of target material to be used are also shown in Table 10. Example of gas target is shown in Table 11 below.

TABLE 10

| Product Nucleus | Target Nucleus | Examples of Target |
|---|---|---|
| ^{117m}Sn | ¹¹⁷Sn | SnO (tin oxide) |
| ^{119m}Sn | ¹¹⁹Sn | SnO (tin oxide) |
| ^{125m}Te | ¹²⁵Te | TeO₂ (tellurium oxide) |
| ^{135m}Ba | ¹³⁵Ba | BaO (barium oxide) |
| ^{179m}Hf | ¹⁷⁹Hf | Hf₂O₃ (hafnium oxide) |
| ^{193m}Ir | ¹⁹³Ir | IrO₂ (iridium oxide) |
| ^{195m}Pt | ¹⁹⁵Pt | PtCl₂ (platinum chloride) |

TABLE 11

| Product Nucleus | Target Nucleus |
|---|---|
| ^{129m}Xe | ¹²⁹Xe |

The energy of the fast neutron to be used is described. Here, the energy of the fast neutron is within a range between a lowermost limit and a highest limit, in which the lowermost limit is a value computed by adding 0.15 to the threshold energy of (n, n′) reaction [unit: MeV], and the highest limit is an energy with which the cross-section of the (n, n′) reaction at the energy is equal to the cross-section of the (n, n′) reaction at the lowermost limit.

### <4> (n, p) Reaction:

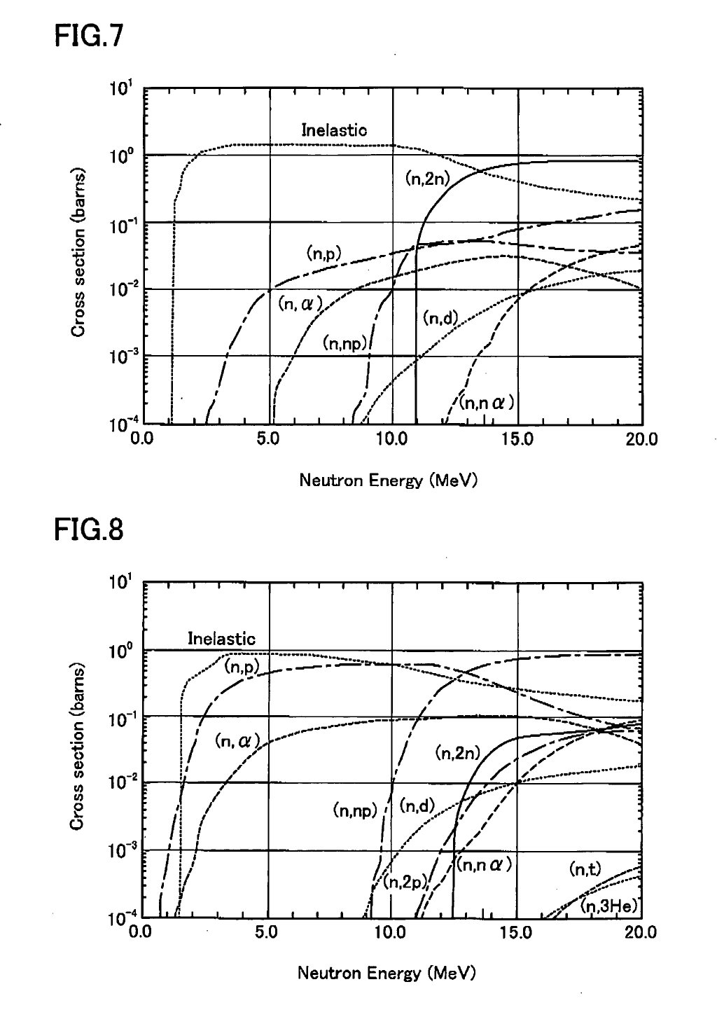

FIG. 7 shows a graph of the neutron energy and the evaluated reaction cross-section in irradiation of a target material having ⁵⁹Co as the target nucleus with fast neutron. From FIG. 7, it is known that, when the target material is irradiated with fast neutron, the (n, p) reaction is predominant depending on the neutron energy value, and has, a large reaction cross-section.

In the invention, a target nucleus in Table 12 to Table 18 below is used, and a radioisotope (product nucleus) is produced through (n, p) reaction. Examples of target material to be used are also shown in Table 12 to Table 17. Examples of gas targets are shown in Table 18 below.

TABLE 12

| Product Nucleus | Target Nucleus | Examples of Target |
|---|---|---|
| ²⁸Al | ²⁸Si | SiO₂ |
| ²⁹Al | ²⁹Si | SiO₂ |
| ³¹Si | ³¹P | P₂O₅ |
| ³²P | ³²S | (NH₄)₂(SO₄) |
| ³³P | ³³S | (NH₄)₂(SO₄) |
| ³⁵S | ³⁵Cl | NaCl |
| ⁴¹Ar | ⁴¹K | K₂CO₃ |
| ⁴²K | ⁴²Ca | CaCO₃ |
| ⁴³K | ⁴³Ca | CaCO₃ |
| ⁴⁴K | ⁴⁴Ca | CaCO₃ |
| ⁴⁵Ca | ⁴⁵Sc | Sc₂O₃ |
| ⁴⁶Sc | ⁴⁶Ti | TiO₂ |
| ⁴⁷Sc | ⁴⁷Ti | TiO₂ |
| ⁴⁸Sc | ⁴⁸Ti | TiO₂ |
| ⁴⁹Sc | ⁴⁹Ti | TiO₂ |
| ⁵⁴Mn | ⁵⁴Fe | Fe₂O₃ |
| ⁵⁶Mn | ⁵⁶Fe | Fe₂O₃ |
| ⁵⁹Fe | ⁵⁹Co | Co₃O₄ |
| ⁵⁸Co | ⁵⁸Ni | NiO |
| ⁶⁰Co | ⁶⁰Ni | NiO |
| ⁶¹Co | ⁶¹Ni | NiO |
| ⁶³Ni | ⁶³Cu | CuO |
| ⁶⁵Ni | ⁶⁵Cu | CuO |

TABLE 13

| Product Nucleus | Target Nucleus | Examples of Target |
|---|---|---|
| ⁶⁴Cu | ⁶⁴Zn | ZnO |
| ⁶⁷Cu | ⁶⁷Zn | ZnO |
| ⁶⁹Zn | ⁶⁹Ga | Ga₂O₃ |
| ⁷¹Zn | ⁷¹Ga | Ga₂O₃ |
| ⁷⁰Ga | ⁷⁰Ge | GeO₂ |
| ⁷²Ga | ⁷²Ge | GeO₂ |
| ⁷³Ga | ⁷³Ge | GeO₂ |
| ⁷⁵Ge | ⁷⁵As | As₂O₃ |
| ⁷⁴As | ⁷⁴Se | SeO₂ |
| ⁷⁶As | ⁷⁶Se | SeO₂ |
| ⁷⁷As | ⁷⁷Se | SeO₂ |
| ⁷⁸As | ⁷⁸Se | SeO₂ |
| ⁸¹Se | ⁸¹Br | KBrO₃ |
| ⁸⁵Kr | ⁸⁵Rb | Rb₂O₃ |
| ⁸⁷Kr | ⁸⁷Rb | Rb₂O₃ |
| ⁸⁴Rb | ⁸⁴Sr | SrO |
| ⁸⁶Rb | ⁸⁶Sr | SrO |
| ⁸⁹Sr | ⁸⁹Y | Y₂O₃ |
| ⁹⁰Y | ⁹⁰Zr | ZrO₂ |
| ⁹¹Y | ⁹¹Zr | ZrO₂ |
| ⁹²Y | ⁹²Zr | ZrO₂ |
| ⁹²Nb | ⁹²Mo | MoO₃ |
| ⁹⁵Nb | ⁹⁵Mo | MoO₃ |
| ⁹⁶Nb | ⁹⁶Mo | MoO₃ |
| ⁹⁹Mo | ^{99g}Tc | ^{99g}Tc |
| ⁹⁶Tc | ⁹⁶Ru | RuCl₂ |
| ⁹⁹Tc | ⁹⁹Ru | RuCl₂ |
| ¹⁰³Ru | ¹⁰³Rh | Rh₂O₃ |
| ¹⁰²Rh | ¹⁰²Pd | PdO |
| ¹⁰⁵Rh | ¹⁰⁵Pd | PdO |
| ¹⁰⁶Rh | ¹⁰⁶Pd | PdO |

TABLE 14

| Product Nucleus | Target Nucleus | Examples of Target |
|---|---|---|
| ¹⁰⁹Pd | ¹⁰⁹Ag | Ag₂O |
| ¹⁰⁶Ag | ¹⁰⁶Cd | CdO |
| ¹¹⁰Ag | ¹¹⁰Cd | CdO |
| ¹¹¹Ag | ¹¹¹Cd | CdO |
| ¹¹²Ag | ¹¹²Cd | CdO |
| ¹¹³Ag | ¹¹³Cd | CdO |
| ¹¹⁵Cd | ¹¹⁵In | In₂O₃ |
| ¹¹²In | ¹¹²Sn | SnO |
| ¹¹⁴In | ¹¹⁴Sn | SnO |
| ¹¹⁶In | ¹¹⁶Sn | SnO |
| ¹¹⁷In | ¹¹⁷Sn | SnO |
| ¹²¹Sn | ¹²¹Sb | Sb₂O₃ |
| ¹²³Sn | ¹²³Sb | Sb₂O₃ |
| ¹²⁰Sb | ¹²⁰Te | TeO₂ |
| ¹²²Sb | ¹²²Te | TeO₂ |
| ¹²⁴Sb | ¹²⁴Te | TeO₂ |
| ¹²⁶Sb | ¹²⁶Te | TeO₂ |
| ¹²⁸Sb | ¹²⁸Te | TeO₂ |
| ¹³⁰Sb | ¹³⁰Te | TeO₂ |
| ¹²⁷Te | ¹²⁷I | NaI |
| ¹³³Xe | ¹³³Cs | Cs₂CO₃ |
| ¹³⁰Cs | ¹³⁰Ba | Ba0 |
| ¹³²Cs | ¹³²Ba | Ba0 |
| ¹³⁴Cs | ¹³⁴Ba | Ba0 |
| ¹³⁵Cs | ¹³⁵Ba | Ba0 |
| ¹³⁶Cs | ¹³⁶Ba | Ba0 |
| ¹³⁸Cs | ¹³⁸Ba | Ba0 |
| ¹³⁹Ba | ¹³⁹La | La₂O₃ |
| ¹⁴⁰La | ¹⁴⁰Ce | Ce₂O₃ |
| ¹⁴²La | ¹⁴²Ce | Ce₂O₃ |

TABLE 15

| Product Nucleus | Target Nucleus | Examples of Target |
|---|---|---|
| ¹⁴¹Ce | ¹⁴¹Pr | Pr₂O₃ |
| ¹⁴²Pr | ¹⁴²Nd | Nd₂O₃ |
| ¹⁴³Pr | ¹⁴³Nd | Nd₂O₃ |
| ¹⁴⁵Pr | ¹⁴⁵Nd | Nd₂O₃ |
| ¹⁴⁴Pm | ¹⁴⁴Sm | Sm₂O₃ |
| ¹⁴⁷Pm | ¹⁴⁷Sm | Sm₂O₃ |
| ¹⁴⁸Pm | ¹⁴⁸Sm | Sm₂O₃ |
| ¹⁴⁹Pm | ¹⁴⁹Sm | Sm₂O₃ |
| ¹⁵⁰Pm | ¹⁵⁰Sm | Sm₂O₃ |
| ¹⁵¹Sm | ¹⁵¹Eu | Eu₂O₃ |
| ¹⁵³Sm | ¹⁵³Eu | Eu₂O₃ |
| ¹⁵²Eu | ¹⁵²Gd | Gd₂O₃ |
| ¹⁵⁴Eu | ¹⁵⁴Gd | Gd₂O₃ |
| ¹⁵⁵Eu | ¹⁵⁵Gd | Gd₂O₃ |
| ¹⁵⁶Eu | ¹⁵⁶Gd | Gd₂O₃ |
| ¹⁵⁷Eu | ¹⁵⁷Gd | Gd₂O₃ |
| ¹⁵⁸Eu | ¹⁵⁸Gd | Gd₂O₃ |
| ¹⁵⁹Gd | ¹⁵⁹Tb | Tb₂O₃ |
| ¹⁵⁶Tb | ¹⁵⁶Dy | Dy₂O₃ |
| ¹⁶⁰Tb | ¹⁶⁰Dy | Dy₂O₃ |
| ¹⁶¹Tb | ¹⁶¹Dy | Dy₂O₃ |
| ¹⁶⁵Dy | ¹⁶⁵Ho | Ho₂O₃ |
| ¹⁶²Ho | ¹⁶²Er | Er₂O₃ |
| ¹⁶⁴Ho | ¹⁶⁴Er | Er₂O₃ |
| ¹⁶⁶Ho | ¹⁶⁶Er | Er₂O₃ |
| ¹⁶⁷Ho | ¹⁶⁷Er | Er₂O₃ |
| ¹⁶⁹Er | ¹⁶⁹Tm | Tm₂O₃ |
| ¹⁶⁸Tm | ¹⁶⁸Yb | Yb₂O₃ |

TABLE 16

| Product Nucleus | Target Nucleus | Examples of Target |
|---|---|---|
| ¹⁷⁰Tm | ¹⁷⁰Yb | Yb₂O₃ |
| ¹⁷²Tm | ¹⁷²Yb | Yb₂O₃ |
| ¹⁷³Tm | ¹⁷³Yb | Yb₂O₃ |
| ¹⁷⁵Yb | ¹⁷⁵Lu | Lu₂O₃ |
| ¹⁷⁴Lu | ¹⁷⁴Hf | Hf₂O₃ |
| ¹⁷⁷Lu | ¹⁷⁷Hf | Hf₂O₃ |
| ¹⁷⁸Lu | ¹⁷⁸Hf | Hf₂O₃ |
| ¹⁷⁹Lu | ¹⁷⁹Hf | Hf₂O₃ |
| ¹⁸¹Hf | ¹⁸¹Ta | Ta₂O₃ |
| ¹⁸²Ta | ¹⁸²W | WO₃ |
| ¹⁸³Ta | ¹⁸³W | WO₃ |
| ¹⁸⁴Ta | ¹⁸⁴W | WO₃ |
| ¹⁸⁵W | ¹⁸⁵Re | ReO₂ |
| ¹⁸⁷W | ¹⁸⁷Re | ReO₂ |
| ¹⁸⁴Re | ¹⁸⁴Os | OsO₂ |
| ¹⁸⁶Re | ¹⁸⁶Os | OsO₂ |
| ¹⁸⁸Re | ¹⁸⁸Os | OsO₂ |
| ¹⁸⁹Re | ¹⁸⁹Os | OsO₂ |
| ¹⁹⁰Re | ¹⁹⁰Os | OsO₂ |
| ¹⁹¹Os | ¹⁹¹Ir | IrO₂ |
| ¹⁹³Os | ¹⁹³Ir | IrO₂ |
| ¹⁹⁰Ir | ¹⁹⁰Pt | PtCl₂ |
| ¹⁹²Ir | ¹⁹²Pt | PtCl₂ |
| ¹⁹⁴Ir | ¹⁹⁴Pt | PtCl₂ |
| ¹⁹⁵Ir | ¹⁹⁵Pt | PtCl₂ |
| ¹⁹⁶Ir | ¹⁹⁶Pt | PtCl₂ |
| ¹⁹⁷Pt | ¹⁹⁷Au | HAuCl₄ |
| ¹⁹⁶Au | ¹⁹⁶Hg | HgCl₂ |
| ¹⁹⁸Au | ¹⁹⁸Hg | HgCl₂ |

TABLE 17

| Product Nucleus | Target Nucleus | Examples of Target |
|---|---|---|
| ¹⁹⁹Au | ¹⁹⁹Hg | HgCl₂ |
| ²⁰⁰Au | ²⁰⁰Hg | HgCl₂ |
| ²⁰¹Au | ²⁰¹Hg | HgCl₂ |
| ²⁰³Hg | ²⁰³Tl | TlO₂ |
| ²⁰⁹Pb | ²⁰⁹Bi | Bi₂O₃ |

TABLE 18

| Product Nucleus | Target Nucleus |
|---|---|
| ⁸⁰Br | ⁸⁰Kr |
| ⁸²Br | ⁸²Kr |
| ⁸³Br | ⁸³Kr |
| ⁸⁴Br | ⁸⁴Kr |
| ¹²⁴I | ¹²⁴Xe |
| ¹²⁶I | ¹²⁶Xe |
| ¹²⁸I | ¹²⁸Xe |
| ¹³⁰I | ¹³⁰Xe |
| ¹³¹I | ¹³¹Xe |
| ¹³²I | ¹³²Xe |
| ¹³⁴I | ¹³⁴Xe |

The product nuclides in the above Table 17 and Table 18 differ from the target nuclides in the element thereof, and therefore can be carrier-free.

The energy of the fast neutron to be used is described. Here, the energy of the fast neutron for irradiation of the target nucleus is within a range between a lowermost limit and a highest limit, in which the lowermost limit is a value computed by adding a number obtained by multiplying the atomic number (Z) of the target material by 0.10 [unit: MeV/number of protons] and 0.2 [unit: MeV] to the Q-value of the (n, p) reaction [unit: MeV], and the highest limit is an energy with which the cross-section of the (n, p) reaction at the energy except the lowermost limit is equal to the cross-section of the (n, p) reaction at the lowermost limit.

### <5> (n, np) Reaction:

FIG. 8 shows an evaluated reaction cross-section on target of ⁵⁸Ni with fast neutron as a function of neutron energy, as an example of (n, np) reaction. From FIG. 8, it is known that, when the target material is irradiated with fast neutron, the (n, np) reaction is predominant depending on the neutron energy, and has a large reaction cross-section.

In the invention, a target nucleus in Table 19 and Table 20 below is used, and a radioisotope (product nucleus) is produced through (n, np) reaction. Examples of target material to be used are also shown in Table 19. Examples of gas targets are shown in Table 20.

TABLE 19

| Product | | |
|---|---|---|
| Nucleus | Target Nucleus | Examples of Target |
| ³³P | ³⁴S | (NH₄)₂(SO₄) |
| ⁴³K | ⁴⁴Ca | CaCO₃ (calcium carbonate) |
| ⁴⁶Sc | ⁴⁷Ti | TiO₂ (titanium oxide) |
| ⁴⁷Sc | ⁴⁸Ti | TiO₂ (titanium oxide) |
| ⁴⁸Sc | ⁴⁹Ti | TiO₂ (titanium oxide) |
| ⁴⁹Sc | ⁵⁰Ti | TiO₂ (titanium oxide) |
| ⁴⁹V | ⁵⁰Cr | CrO₂ (chromium oxide) |
| ⁵⁷Co | ⁵⁸Ni | NiO (nickel oxide) |
| ⁶¹Co | ⁶²Ni | NiO (nickel oxide) |
| ⁶⁷Cu | ⁶⁸Zn | ZnO (zinc oxide) |
| ⁷²Ga | ⁷³Ge | GeO₂ (germanium oxide) |
| ⁷³Ga | ⁷⁴Ge | GeO₂ (germanium oxide) |
| ⁷³As | ⁷⁴Se | SeO₂ (selenium oxide) |
| ⁷⁶As | ⁷⁷Se | SeO₂ (selenium oxide) |
| ⁷⁷As | ⁷⁸Se | SeO₂ (selenium oxide) |
| ⁹¹Nb | ⁹²Mo | MoO₃ (molybdenum oxide) |
| ¹⁰¹Rh | ¹⁰²Pd | PdO (palladium oxide) |

TABLE 20

| Product Nucleus | Target Nucleus |
|---|---|
| ³⁹Cl | ⁴⁰Ar |
| ⁷⁷Br | ⁷⁸Kr |
| ⁸²Br | ⁸³Kr |
| ⁸³Br | ⁸⁴Kr |

The element of the product nuclei in the (n, np) reaction in the above Table 19 and Table 20 differ from that of the targets, and therefore can be all carrier-free.

The energy of the fast neutron to be used is described. Here, the energy of the fast neutron for irradiation is within a range between a lowermost limit and a highest limit, in which the lowermost limit is a value computed by adding a number obtained by multiplying the atomic number (Z) of the target material by 0.10 [unit: MeV/number of protons] and 0.2 [unit: MeV] to the threshold energy in the (n, np) reaction [unit: MeV], and the highest limit is an energy with which the cross-section of the (n, np) reaction at the energy except the lowermost limit is equal to the cross-section of the (n, p) reaction at the lowermost limit.

### <6> (n, ⁴He) Reaction:

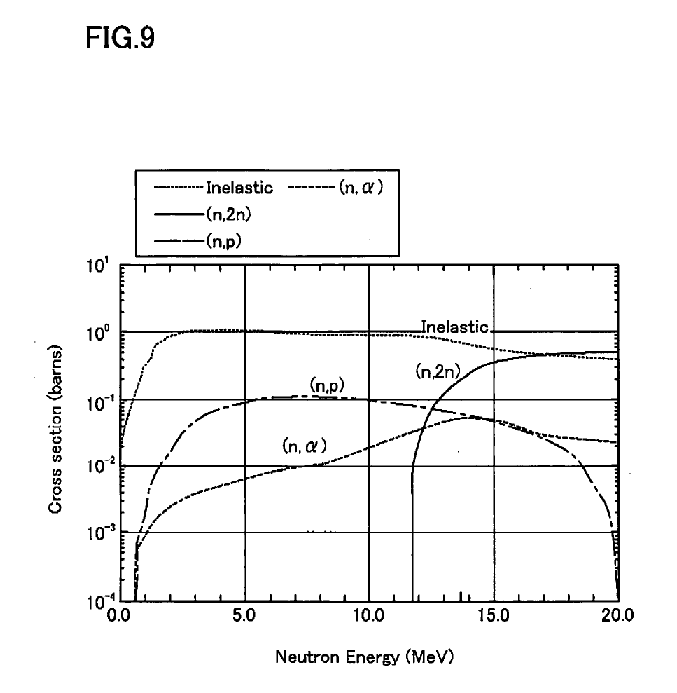

FIG. 9 shows an evaluated reaction cross-section on target of ⁴⁵Sc with fast neutron as a function of neutron energy, as an example. From FIG. 9, it is known that, when the target material is irradiated with fast neutron, the (n, ⁴He) reaction is predominant depending on the neutron energy, and has a large reaction cross-section.

In the invention, target nuclei in Table 21 below are used, and a radioisotope (product nucleus) is produced through (n, ⁴He) reaction. Examples of target material to be used are also shown in Table 21.

TABLE 21

| Product Nucleus | Target Nucleus | Examples of Target |
|---|---|---|
| ²⁴Na | ²⁷Al | aluminium oxide (Al₂O₃) |
| ³²P | ³⁵Cl | sodium chloride (NaCl) |
| ³⁸Cl | ⁴¹K | potassium carbonate (K₂CO₃) |
| ³⁷Ar | ⁴⁰Ca | calcium carbonate (CaCO₃) |
| ⁴¹Ar | ⁴⁴Ca | calcium carbonate (CaCO₃) |
| ⁴²K | ⁴⁵Sc | scandium oxide (ScO) |
| ⁴⁵Ca | ⁴⁸Ti | titanium oxide (TiO₂) |
| ⁴⁷Ca | ⁵⁰Ti | titanium oxide (TiO₂) |
| ⁴⁸Sc | ⁵¹V | vanadium oxide (V₂O₅) |
| ⁵¹Cr | ⁵⁴Fe | iron oxide (Fe₂O₃) |
| ⁵⁶Mn | ⁵⁹Co | cobalt oxide (Co₃O₄) |
| ⁵⁵Fe | ⁵⁸Ni | nickel oxide (NiO) |
| ⁵⁹Fe | ⁶²Ni | nickel oxide (NiO) |
| ⁶⁵Ni | ⁶⁸Zn | zinc oxide (ZnO) |
| ⁶⁹Zn | ⁷²Ge | germanium oxide (GeO₂) |
| ⁷¹Zn | ⁷⁴Ge | germanium oxide (GeO₂) |
| ⁷²Ga | ⁷⁵As | arsenic oxide (As₂O₃) |
| ⁷⁵Ge | ⁷⁸Se | selenium oxide (SeO₃) |
| ⁷⁷Ge | ⁸⁰Se | selenium oxide (SeO₃) |
| ⁷⁶As | ⁷⁹Br | potassium hydrobromide (KBrO₃) |
| ⁷⁸As | ⁸¹Br | potassium hydrobromide (KBrO₃) |
| ⁸⁵Kr | ⁸⁸Sr | strontium oxide (SrO) |
| ⁸⁶Rb | ⁸⁹Y | yttrium oxide (Y₂O₃) |
| ⁸⁹Sr | ⁹²Zr | zirconium oxide (ZrO₂) |
| ⁹¹Sr | ⁹⁴Zr | zirconium oxide (ZrO₂) |
| ⁸⁹Zr | ⁹²Mo | molybdenum oxide (MoO₃) |
| ⁹⁵Zr | ⁹⁸Mo | molybdenum oxide (MoO₃) |
| ⁹⁷Zr | ¹⁰⁰Mo | molybdenum oxide (MoO₃) |
| ⁹⁹Mo | ¹⁰²Ru | ruthenium oxide (RuO) |
| ¹⁰³Ru | ¹⁰⁶Pd | palladium oxide (PdO) |
| ¹⁰⁵Ru | ¹⁰⁸Pd | palladium oxide (PdO) |
| ¹⁰⁶Rh | ¹⁰⁹Ag | silver oxide (Ag₂O) |
| ¹⁰³Pd | ¹⁰⁶Cd | cadmium oxide (CdO) |
| ¹⁰⁹Pd | ¹¹²Cd | cadmium oxide (CdO) |
| ¹¹¹Pd | ¹¹⁴Cd | cadmium oxide (CdO) |
| ¹¹²Ag | ¹¹⁵In | indium oxide (In₂O₃) |

The element of the product nuclei differ from that of the targets thereof, and therefore can be all carrier-free.

The energy of the fast neutron to be used is described. Here, the energy of the fast neutron for irradiation is within a range between a lowermost limit and a highest limit, in which the lowermost limit is a value computed by adding 1.2 (in case where the target nucleus is ⁴⁸Ti, ⁵⁰Ti, ⁸⁰Se or ⁹⁸Mo, 6.0) to the threshold energy in the (n, ⁴He) reaction [unit: MeV], and the highest limit is an energy with which the cross-section of the (n, ⁴He) reaction at the energy except the lowermost limit is equal to the cross-section of the (n, ⁴He) reaction at the lowermost limit.

For RI production in the invention, a nuclear reactor is not used, but the target material is irradiated with fast neutron generated by the use of a compact accelerator. In that manner, a large amount of radioactive waste is not produced and the radioactivity of the waste can be reduced, as compared with a case of producing radioisotope in fission reaction in a nuclear reactor.

The compact accelerator for generating fast neutron may be, for example, a commercially-available one, or may be a facility of a D-T neutron source in a fusion neutronics source (FNS) of the Japan Atomic Energy Agency that is the present applicant's facility.

In the neutron-generating accelerator, for example, tritium (³H) is irradiated with a deuteron (²H) beam to produce fast neutron and helium (⁴He) according to the following reaction:

²H+³H→4He+n

The neutron energy (En) to be produced through the reaction is given by the following formula:

4×En=Ed+2×{2×Ed×En}^{1/2}×cos θ+3×Q

where Ed is deuteron energy; Q is the generated energy in the reaction, and Q=17.6 MeV. θ is an angle between the formed neutron and the incident deuteron. According to this formula, it is known that, for example, when low-energy deuteron with 0.35 MeV is used, fast neutron with 14 MeV can be obtained. In the International Fusion Material Irradiation Facility (IFMIF) where a project is now under way, liquid lithium (Li) is irradiated with deuteron to produce high-intensity fast neutron. Further, when irradiated with proton or deuteron, metal Li or metal beryllium (Be) or carbon (C) may generate fast neutron.

Here, the production efficiency of RI by the fast neutron is investigated by the example of ⁹⁹Mo produced by ¹⁰⁰Mo (n,2n) reaction. The amount of ⁹⁹Mo to be produced through fission reaction in a nuclear reactor (Y_{reactor}) is given by the following formula:

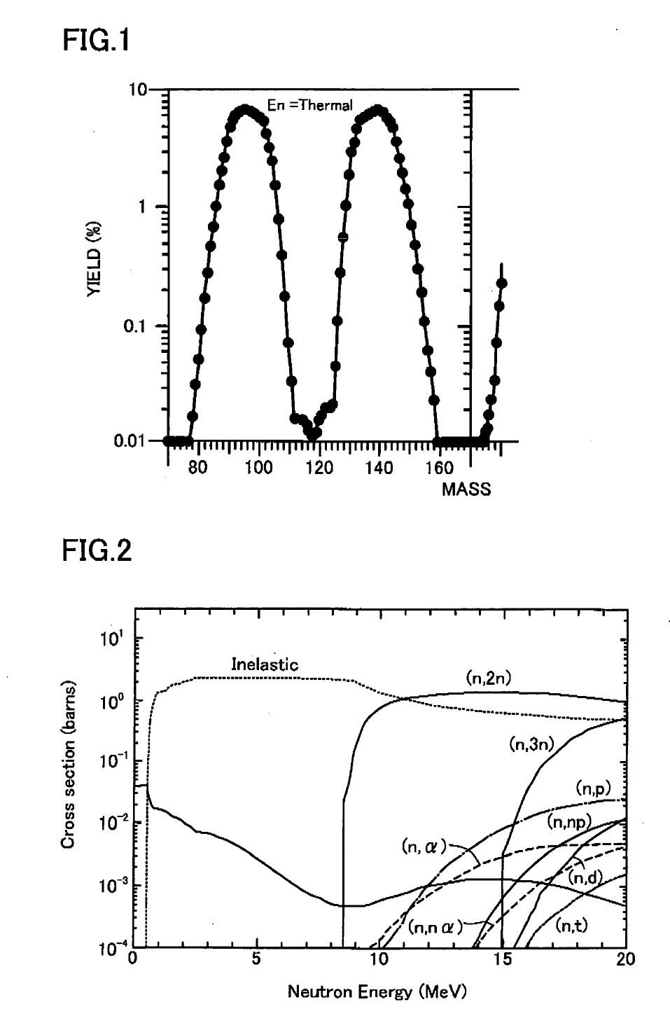

²³⁵U: enrichment 20%. The fission cross-section area of the reaction of thermal neutron with ²³⁵U is 585 barn. In this reaction, the fission yield of ⁹⁹Mo is 6% (see FIG. 1). From the above values, the amount of ⁹⁹Mo to be produced in this ²³⁵U fission is given by 0.20×585×0.06=7 barn.

¹⁰⁰Mo: natural abundance 9.6%. The ⁹⁹Mo producing reaction cross-section with fast neutron is 1.5 barn. From the above values, the amount of ⁹⁹Mo to be produced from natural Mo is given by: (Y_{fast neutron})=0.096×1.5=0.14 barn.

Accordingly,

the ratio of

Y_{fast neutron} to Y_{reactor}=Y_{fast neutron}/Y_{reactor}=0.14/7=0.02 Formula (1).

The yield of ⁹⁹Mo by the accelerator with fast neutron is 2% of that in reactor except the neutron flux.

The Neutron Flux is as Follows:

The flux of thermal neutron in reactor, φ_{reactor}: In the nuclear reactor facility for research of the Japan Atomic Energy Agency, JRR3,

φ_{reactor}=10¹⁴/(cm²·sec) Formula (2).

The flux of fast neutron, φ_{fast neutron}: In IFMIF,

φ_{fast neutron}=1014/(cm²·sec) Formula (3).

Accordingly, the ratio of the flux of fast neutron to that of the thermal neutron in reactor is

φ_{fast neutron}/φ_{reactor}=1 Formula (4).

In the above, when the neuron flux is taken into consideration, the ratio of the ⁹⁹Mo yield from fast neutron to the ⁹⁹Mo yield in a nuclear reactor is given by the following formula:

0.02×1=0.02 Formula (5).

Here, the matter that high enriched ¹⁰⁰Mo can be obtained with relative ease is taken into consideration (for example, in 100% enrichment), the ratio of the formula (5) is to be as follows, from the formula (I) and the formula (4):

0.02÷9.6×100=0.21 Formula (6).

In other words, it is known that, according to the invention using fast neutron, ⁹⁹Mo can be produced in an amount comparable to the yield in a reactor. The above shall apply to the other targets to which the invention is directed.

In case where metal lithium (Li) is irradiated with proton to generate neutron, the neutron energy (En) obtained in this reaction {p+⁷Li→n+⁷Be} is given by the following formula:

En={R×cos θ+(1−R²×sin² θ)^{1/2}}²×{M_{Be}×(E_{cm}+Q)/(M_{Be}+Mₙ)}

R=[Mₙ×Mₚ×E_{cm}/{M_{Be}×M_{Li}×(E_{cm}+Q)}]^{1/2}

E_{cm}=M_{Li}×Eₚ/(M_{Li}+Mₚ)

where Eₚ is proton energy; Mₚ, Mₙ, Mᵤ and M_{Be} are rest masses of proton, neutron, Li and Be, respectively. θ is an angle between neutron generated by this reaction and proton beam direction. Q is a threshold energy of this reaction and Q=−1.644 MeV.

According to this formula, it is known that, for example, when high-energy proton with 16 MeV is used, fast neutron with about 14 MeV can be obtained in the direction of 0=0. Neutron produced in the manner as above is released in the direction of the proton beam, and therefore, it is important that the target is set on the beam line.

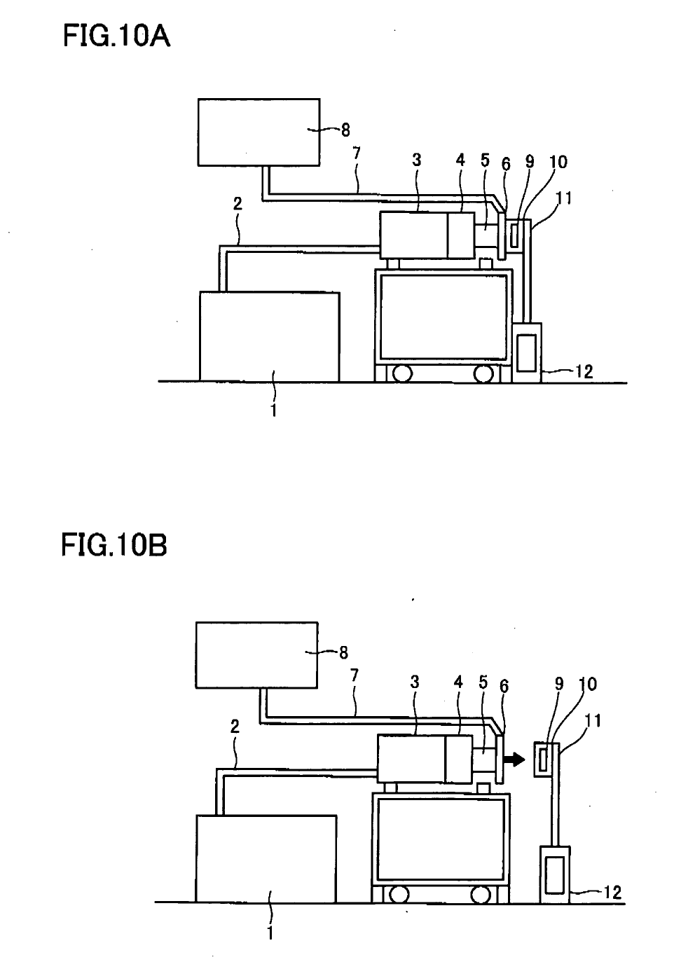

FIG. 10 schematically shows an RI production apparatus of one embodiment of the invention.

In the figure, 1 is a high-voltage power supplier; 2 is a power cable; 3 is an accelerator terminal; 4 is an accelerator tube; 5 is a deuteron transportation line; 6 is a fast neutron generating part; 7 is a cooling pipe; 8 is a cooling system; 9 is a target material; 10 is a target supporting frame or a sample container; 11 is a target supporting board; 12 is a radiation-shielded RI container (target storage). FIG. 10A and FIG. 10B show a state where the target material 9 is contacted and a state where the target material 9 is separated from the fast neutron generating part 6, respectively.

The RI production efficiency is large when the target material 9 is contacted with the fast neutron generating part 6 as in FIG. 10A. In this case, the target material 9 or the sample container 10 housing it is contacted with the fast neutron generating part 6 and the top of the cooling pipe 7, for example, via a cooling material formed of Cu. In this case, the cooling material provided in the fast neutron generating part 6 shall have a separation ability between the vacuum chamber of the deuteron transportation line 5 and the air side where the target material 9 is placed. In some cases, the target material 9 may be spaced from the fast neutron generating part 6 by a distance of up to 10 mm or so, as shown in FIG. 10B, and the distance is not limitative.

The high-voltage power supplier 1 outputs a high voltage so as to make the deuteron beam energy of around 0.35 MeV for producing a large amount of neutrons through the above-mentioned neutron generating reaction. The power cable 2 is for imparting the high voltage from the high-voltage power supplier 1 to the accelerator tube 4 adjacent to the accelerator terminal 3. In the fast neutron generating part 6, for example, a vapor deposition film of titanium or the like with absorbed tritium is disposed on a metal plate with high thermal conductivity such as Cu; and the fast neutron generating part 6 plays a role of inducing the above-mentioned neutron generating reaction to thereby produce a large amount of neutrons. The cooling system 8 plays a role of cooling the metal plate via the cooling pipe 7 for the purpose of preventing thermal diffusion of the tritium in the metal plate irradiated with deuteron beams. The water or the like is used for the cooling. The metal plate may be a stationary or rotary type.

As the solid target material 9 in the invention, usable is an oxide powder or the like of a target with natural abundance or with an enriched abundance; or a pellet prepared by compression-molding the powder to have a high density (bulk density of at least 60%) (for example, JP-A 55-22102). In the case where an enriched target element is used, it requires pretreatment of electromagnetic separative collection or the like. In the case where a powder of an oxide with target element or the like is used, it must be sealed up in a quartz tube and must be further sealed up in an aluminium-based metallic irradiation container. In the case where a pellet formed of a powder of an oxide with target element or the like is used, it is directly sealed up in a metallic irradiation container. The metallic irradiation container is the sample container 10. In addition, a target element metal may also be used as the target. In this case, however, dissolution in nitric acid or the like is required for the extraction of the target element metal.

In the case where a pellet is used as the target material 9, its dimension may be, for example, a diameter of 10 mm and a thickness of 0.5 mm; but needless-to-say, it is one example. Not limited thereto, the pellet may have any suitable shape and dimension depending on the fast neutron irradiation energy, the yield, etc. In this case, when the target material 9 is too thick, it may cause a problem of neutron scattering and the production yield may be thereby lowered; and accordingly, these points must be taken into consideration. Neutrons are emitted from the accelerator terminal 3 in all directions, and the neutron flux (neutrons/cm²·sec) reduces at 1/r². Accordingly, the RI production efficiency is the maximum in the constitution where the target material 9 is contacted with the neutron generating part 6 of the accelerator terminal 3.

The target material 9 is fixed to or housed in the target supporting frame or sample container 10. The target supporting board 11 plays a role of fixing the target supporting frame or sample container 10. The RI container 12 is provided with a radiation shield; and the produced RI is put in it, then taken out of the laboratory, and transported or moved to a desired site. The parts other than the RI container 12 are shielded from radiation, if needed.

The target is irradiated with neutron in the apparatus having the constitution as above, and the irradiation time may be determined in consideration of the half-life of the nuclide produced. For nuclei with a short half-life, the half-life may be taken as the guide for the irradiation time, and for nuclei with a half-life longer than 5 days, about 5 days or so may be taken as the irradiation time thereby obtaining a desired amount of the intended RI. In this case, since fast neutron from the accelerator is used and nuclear fission is not employed, a large amount of radioactive waste is not formed, and in addition, since the nuclear reaction having a relatively large reaction cross-section is employed, the intended RI can be stably produced at high efficiency. Further, a commercially-available accelerator can be used, and the apparatus constitution may be extremely compact. Therefore, the invention has made it possible to stably produce and utilize RI in a simplified manner in facilities such as hospitals, etc.

In case where the reaction threshold energy of the target is 15 MeV or higher, an apparatus having the constitution mentioned below is used. The high-voltage power source 1 outputs a high voltage of, for example, making the proton beams have an energy of around 25 MeV or so, for the purpose of forming a large amount of neutrons in the above-mentioned neutron producing reaction. The power cable 2 is for imparting the high voltage from the high-voltage power supplier 1 to the accelerator tube 4 adjacent to the accelerator terminal 3. In the fast neutron generating part 6, a thin film of metal Li is disposed on a metal plate with excellent thermal conductivity such as Cu; and the fast neutron generating part 6 plays a role of inducing the above-mentioned neutron producing reaction therein to form a large amount of neutrons. The cooling system 8 plays a role of cooling the metal plate via the cooling pipe 7 for the purpose of preventing thermal diffusion of Li in the surface of the Cu metal plate irradiated with proton beams. The water or the like is used for the cooling. The metal plate may be a stationary or rotary type. In this case, neutrons are emitted from the fast neutron generating part 6 almost entirely along the proton beam direction. Preferably, therefore, the target material 9 is disposed while contacted with or kept adjacent to (as spaced by at most up to 10 mm or so) the fast neutron generating part 6.

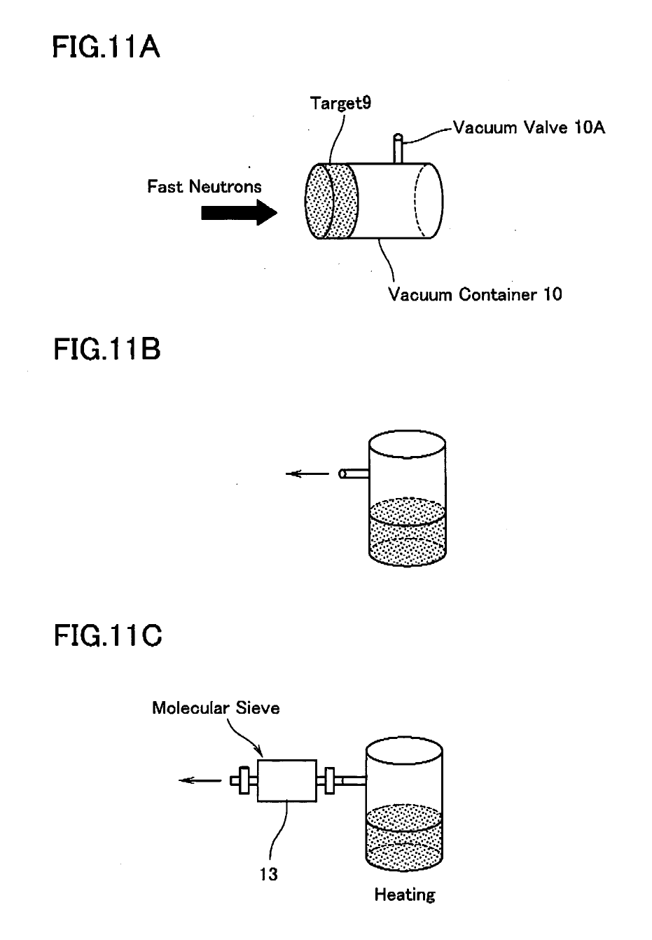

In case where the RI to be produced is gas, a sample container 10 as in FIG. 11A is used. In case where the target material 9 is gas, a sample container 10 having a similar constitution may be used. In this case, the sample container 10 to be used is a container of stainless steel having high airtightness. The sample container 10 is provided with a vacuum valve 10A, through which the produced RI can be discharged out. In case where a gaseous RI is produced through irradiation of a solid target nucleus with fast neutron, the sample container 10 of the illustrated type is used.

When a gaseous RI is produced, a solution of an alkali such as sodium hydroxide or an acid such as hydrochloric acid or the like is put into the sample container 10, and stirred to dissolve therein the gaseous RI formed through the nuclear reaction. Next, the vacuum valve 10A is connected to a vapor collector 13 as in FIG. 11B and FIG. 11C. Here, the sample container is heated and the dissolved gaseous RI is emitted in vacuum and then introduced into the vapor collector 13. In the vapor collector 13, for example, the gaseous RI is adsorbed by an adsorbent agent such as molecular sieve or the like. In this, if desired, the vapor collector 13 may be cooled with liquid nitrogen or the like. The remaining solid target may be recycled.

Next described is another embodiment of the invention.

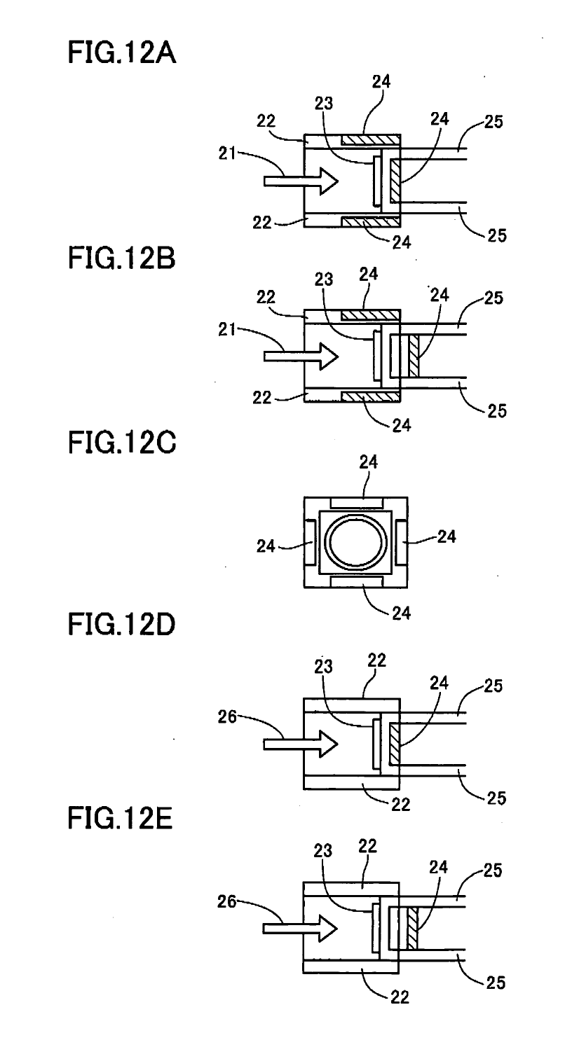

FIG. 12 schematically shows the substantial parts of an RI production apparatus of another embodiment of the invention. FIG. 12A is a schematic view seen in the direction vertical to the deuteron beam direction, in which the fast neutron generating part and the target material are contacted each other. In FIG. 12B, the fast neutron generating part and the target material are separated from each other. FIG. 12C is a schematic view seen in the deuteron beam direction. In the figure, 21 is a deuteron beam; 22 is a rectangular parallelepiped vacuum beam tube; 23 is a copper plate having a tritium-adsorbed titanium film; 24 is a target material; 25 is a cooling material; 26 is a proton beam. The cooling material 25 may be integrated with the copper plate 23, and in this case, the copper plate 23 has an inner wall and an outer wall. On the surface of the inner wall (on the vacuum chamber side) of the copper plate 23, provided is the tritium-adsorbed titanium film; and on the surface of the outer wall (on the air side) of the copper plate, disposed is the target material 24 as contacted each other, or as separated from each other, and a cooling medium such as water or the like may run through the space between the inner wall and the outer wall.

Fast neutrons to be formed through irradiation of tritium (³H) with the deuteron (²H⁺) beam 21 are characterized by the fact that a large amount of neutrons are isotropically emitted to almost the entire space irrespective of the incident direction of the deuteron beam 21. Therefore, the target material 24 is arranged in the manner mentioned below in order that the produced neutrons can be utilized to the utmost extent within a limited neutron utilization time. The target material 24 may be, for example, a pellet prepared by compressing a powder of an oxide of a natural target element or an enriched target followed by sintering it; or a target element metal such as that mentioned above may be used for it.

For preventing thermal diffusion of tritium in irradiation of the copper plate 23 having a tritium-containing titanium plate fitted thereto, on which the high-intensity deuteron beam 21 increases the titanium temperature, the copper plate 23 having a tritium-containing titanium plate fitted thereto is cooled via the cooling pipe 25. In order to use the deuteron beam 21 having a higher intensity within a given cooling power range, it may be taken into consideration to reduce the thermal load per unit area given by the deuteron beam 21. Accordingly, the size of the deuteron beam 21 may be changed to, for example, 10 mm in diameter from an ordinary size thereof of 5 mm in diameter, by changing the beam transportation system of the accelerator. As a result, the thermal load per unit area may be reduced to ¼, and the intensity of the deuteron beam may be increased up to 4 times that of a conventional deuteron beam, and therefore the usable amount of the produced neutrons may increase by a factor of 4. In addition, since the fast neutrons are emitted isotropically to the entire space, the target material 24 may be set not only in the front of the deuteron beam 21 but also on the sides as in FIG. 12C.

Via the vacuum beam transportation system of the rectangular parallelepiped vacuum beam tube 22, the deuteron beam 21 is radiated to the copper plate 23 having a tritium-containing titanium film. With that, the fast neutron produced through the reaction of ²H⁺+³H→⁴He+n is radiated to the target material 24 disposed on the air side of the cooling material 25 (copper plate 23) (in the closest distance). On the other hand, for the purpose of efficiently utilizing the fast neutron emitted backward relative to the deuteron beam 21 that enters the copper plate 23 having a tritium-containing titanium film, at a right angle, the four faces of the vacuum beam tube (rectangular parallelepiped) 22 adjacent to the fast-neuron producing site are processed and the target material 24 is implanted as illustrated. In that constitution, fast neutrons can be emitted isotropically to the entire space and therefore the RI production can be attained highly efficiently.

In case where neutron with a higher energy is used, Li, Be or carbon (C) is irradiated with proton or the like, as mentioned above. In this case, almost all neutron fluxes are emitted in the direction of the proton beam. Accordingly, the disposition of the target material 24 is in front of the fast neutron generating part as shown in FIGS. 12D and 12E. FIG. 12D is a case where the target material 24 is contacted with the fast neutron generating part; and FIG. 12E is a case where the target material 24 is separated from the fast neutron generating part. As in the above, according to the invention, the target material 24 may be disposed not in vacuum but on the side of air; and therefore, the invention has an advantage in that the latitude of the form and the configuration of the target material 24 can be broadened.

Next described is a method of producing RI according to the invention.

The RI production method of the invention is basically characterized in that a target material containing a target nucleus is irradiated with fast neutron from an accelerator to induce various reactions as mentioned above, thereby producing RI.

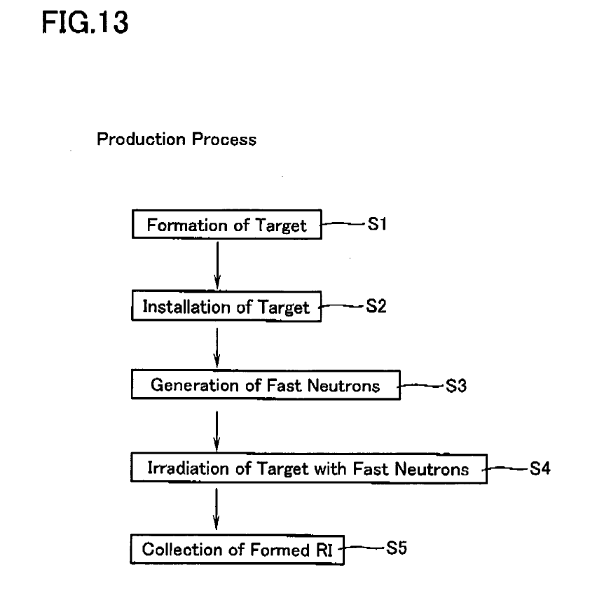

One example of the RI production method of the invention is described below with reference to the block diagram of the production flowchart of FIG. 13.

First, for example, a natural target element is used, and a powder of its oxide or the like is compressed, molded and sintered to prepare a pellet-like target material (step S1).

Next, the target material is put into a sample container, and set in a position for neutron irradiation (step S2).

Next, from a neutron generating apparatus, for example, a deuteron beam with 0.35 MeV is radiated to the tritium-containing titanium film set on a cooling copper plate. Accordingly, fast neutron of 14 MeV is generated (step S3).

When irradiated with the fast neutron, the target material to which the invention is directed induces various reactions as mentioned above thereby producing RI (step S4).

After neutron irradiation for a suitable period of time, the irradiation is stopped, and then the sample container with RI therein is taken out, from which the intended RI is collected (step S5).

In that manner, it is possible to efficiently produce the intended RI from the target material in the invention, according to the same method as above using fast neutron to be generated through irradiation of a metal Li (lithium) or a metal Be (beryllium) or carbon (C) with a proton beam or a deuteron beam, not producing a large amount of radioactive waste.

In case where the product nucleus and the target nucleus are the same element, the irradiated target (in which both the target and the reaction product exist together) may be dissolved in an aqueous solution (or an acid or alkali), and thud, the product nucleus may be used.

Further, in case where the product nucleus is a long lived RI relative to the short-lived RI of the daughter nuclide, it may be subjected to milking in a system of a so-called cow milking system or a generator system.

One example of a production method is described in the above; needless-to-say, however, the production method of the invention is not limited to this example, and various modes described above may be used in the constitutive steps in the method.

### EXAMPLES

Examples of the invention are described below.

### Example 1

The present inventors made the following experiment for the purpose of confirming the production of RI through irradiation of a target material with a fast neutron beam from an accelerator. Here is described is an example of using radioactive molybdenum ⁹⁹Mo, a parent nuclide of radioactive technetium ^{99m}Tc that is extremely frequently used as a radioactive diagnostic agent.

### <Object of Experiment>

To confirm the production of ⁹⁹Mo from a natural Mo sample with fast neutron of 14 MeV, in a predicted reaction cross-section.
To confirm the measurement of the radiation of ⁹²Nb produced from a ⁹³Nb sample for use in determination of the absolute value of the above-mentioned reaction cross-section, with 14 MeV neutron, and the application thereof to determination of the cross-section.
To quantitatively evaluate the residual radioisotope produced in ⁹⁹Mo formation reaction.
To confirm the stable production of 14 MeV neutron with the intended neutron intensity in reaction of ²H+³H→⁴He+n (to evaluate the quality of ³H target).
To confirm the stable supply of ²H (deuteron beam) for inducing the above reaction (verification of stable operation of compact accelerator).
To confirm the easy and flexible installation and de-installation of Mo target and Nb target in neutron irradiation site.

### <Place for Experiment>

Fusion Neutronics Source (FNS) of the Japan Atomic Energy Agency.

### <Date of Experiment>

Neutron irradiation experiment: From January 27 to Jan. 30, 2009 (irradiation for 6 hours/day).
Measurement of radioactivity of produced Mo: From January 27 to Feb. 5, 2009.

### <Sample> Natural Mo

Sample 1: diameter, about 10 mm; thickness, about 50 microns (0.05 mm); weight, 40.214 mg.
Sample 2: diameter, about 10 mm; thickness, about 5 microns (0.005 mm); weight, 3.663 mg.

Sample 1 was irradiated for 6 hours and then analyzed.

Sample 2 was irradiated with neutron until the final date, and then analyzed.

### <Sample> ⁹³Nb

Sample 3: diameter, 10 mm; thickness, 0.1 mm; weight, 69.4 mg.

### <Mo Target Installed Place>

Spaced from the neutron generating site by 10 cm, in the extended direction of the ²H beam axis.

### <Neutron Irradiation Condition>

14 MeV neutron production reaction:

²H+³H→4He+n: ²H beam energy: 0.35 MeV.
Neutron yield:
   1.8×10¹¹ n/cm²·sec [January 27] to 1.5×10¹¹ n/cm²·sec (January 30) at the generation site.

### <⁹⁹Mo Production Reaction>

¹⁰⁰Mo+n→⁹⁹Mo+2n.

### <⁹²Nb Production Reaction>

⁹³Nb+n→⁹²Nb+2n.

<Measurement of ⁹⁹Mo and residual radioactivity (measurement in FNS)>
Condition for measurement: Measurement was started after a cooling period of about 1 hour after neutron irradiation.
Tester: Ge semiconductor detector.
⁹⁹Mo sample and ⁹²Nb sample arrangement: Set as spaced from Ge detector by 5 cm.

### <Results>

It was confirmed that ⁹⁹Mo was produced in the originally-predicted amount.
It was confirmed that the ⁹³Nb sample could be used in determination of the ⁹⁹Mo cross-section.
The residual radioisotope formed in the ⁹⁹Mo production reaction was quantitatively evaluated. (It was confirmed that the amount was only a small amount as compared with the amount of ⁹⁹Mo.)
It was confirmed that the 14 MeV neutron produced through the reaction ²H+³H→⁴He+n had the expected neutron intensity and that it was produced stably (the ³H target was evaluated to have a high quality).
It was confirmed that ²H (deuteron beam) to induce the above reaction could be supplied stably.

### (Verification of Stable Operation of Compact Accelerator)

It was confirmed that the installation and the de-installation of the Mo target and the Nb target in the neutron irradiation site was easy and flexible.

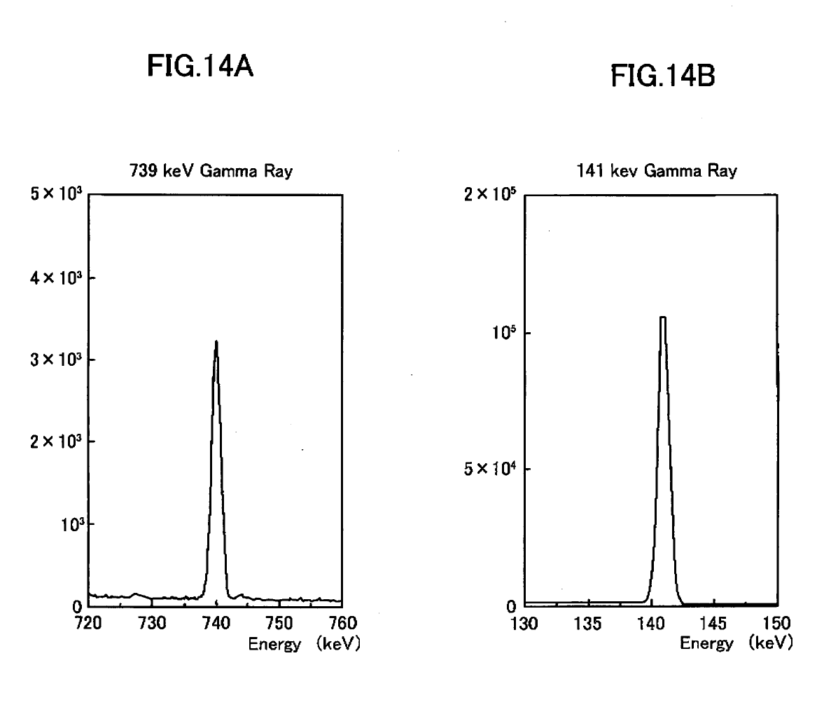

In addition, it was confirmed that the product produced under the above-mentioned condition was ⁹⁹Mo by detection of gamma ray with a high-performance germanium semiconductor detector. The semiconductor detector was set at a position of 5 cm from the sample. The results are in FIG. 14. FIG. 14A shows the measurement data of the 739 keV gamma ray emitted through ⁹⁹Mo beta decay; and FIG. 14B shows the measurement data of the 141 keV gamma ray emitted from the condition of ^{99m}Tc excited in ⁹⁹Mo beta decay. It was confirmed that ⁹⁹Mo was produced with 14 MeV fast neutron.

Next described is an example of milking in application of the sample actually produced according to the molybdic acid-mixed titanic acid gel production method mentioned in the above, to a ⁹⁹Mo/^{99m}Tc generator.

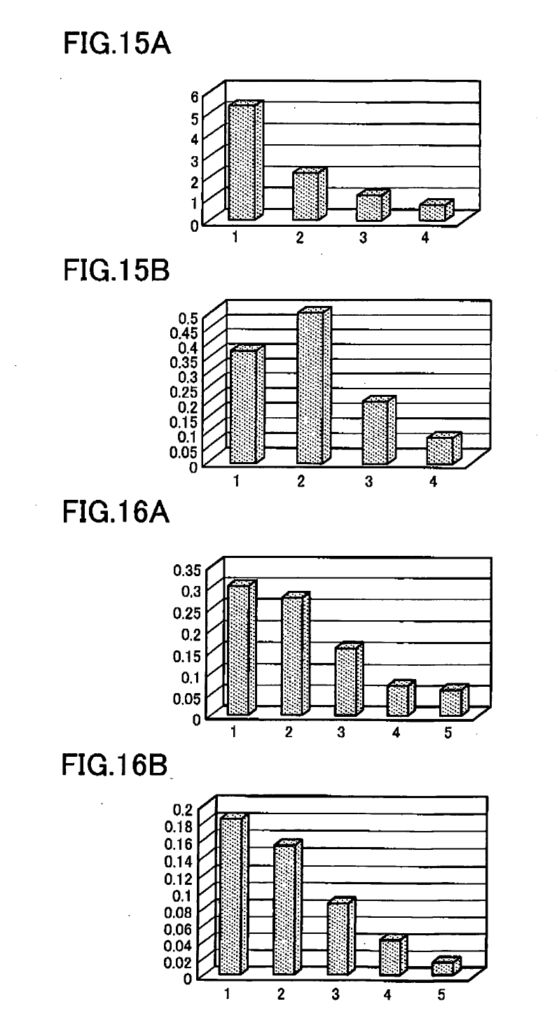

First, a titanic acid gel irradiated with fast neutron was taken in a beaker. Each 2 ml of the portion of the gel was washed with water for a total of four times. The resulting supernatant was dried, and the change in the gamma ray intensity of ^{99m}Tc was checked with the above-mentioned semiconductor detector. The results are in FIG. 15A. FIG. 15B shows the results in the same measurement where physiological saline was used in place of water.

Next, the same titanic acid gel as above that had been irradiated with fast neutron was put into a glass tube, from which ^{99m}Tc was eluted with water and then subjected to milking. Five drops (one drop weighed 0.274 mg) were separated and dried, and the change in the gamma ray intensity of ^{99m}Tc in each drop was checked. The results are shown in FIG. 16A. FIG. 16B shows the results in the same measurement where physiological saline was used in place of water.

From the above, the production of ^{99m}Tc was confirmed.

In the case of titanic acid gel, the influence of Sc on the Ti irradiation with neutron can be prevented by connecting an alumina column in series to the generator with a radioactive molybdenum-containing material; and in such a manner, carrier-free ^{99m}Tc having a higher purity can be obtained.

^{99m}Tc obtained through beta decay of ⁹⁹Mo produced according to the invention is applicable especially to the following medical examination and treatment in the field of medical care, in the form thereof mentioned below.

### (1) Function Test: Lung Circulation Function, Cardiac Output, Lung Blood Amount

Technetium human serum albumin (^{99m}Tc-HSA)

### (2) Function Test: Thyroidal Intake

Sodium pertechnetate

### (3) Brain Scintigraphy:

Sodium pertechnetate, technetium methylenediphosphonate (^{99m}Tc-MDP)

### (4) Cerebral Blood Flow Scintigraphy:

Technetium exametazime (hexamethylpropylene-amine oxime) (^{99mM}-Tc-HM-PAO), N,N′-ethylenedi-L-cysteinate(3)oxotechnetium diethyl ester

### (5) Thyroidal Scintigraphy:

Sodium pertechnetate

### (6) Lung Blood Flow Scintigraphy:

Technetium macroaggregated human serum albumin (^{99m}Tc-MAA)

### (7) Cardiac Muscle Scintigraphy:

Hexakis(2-methoxyisobutylisonitrile)technetium (^{99m}Tc-MIBI), tetrofosmin technetium, technetium pyrophosphate (^{99m}Tc-PYP)

### (8) Cardiac Pool Scintigraphy:

Technetium human serum albumin (^{99m}Tc-HSA), technetium human serum albumin diethylenetriamine-pentaacetate (^{99m}Tc-HSA-DTPA)

### (9) Hepatic Scintigraphy:

Technetium tin colloid, technetium phytate, technetium galactosyl human serum albumin diethylenetriamine-pentaacetate (^{99m}Tc-GSA)

### (10) Hepato-Cholescintigraphy:

Technetium N-(2,6-dimethylphenylcarbamoylmethyl)iminodiacetate (^{99m}Tc-HIDA), technetium diethylacetanilidoimino-diacetate, pyridoxylidene-isoleucine technetium (^{99m}Tc-PI), N-pyridoxyl-5-methyltriptophane technetium (^{99m}Tc-PMT),

### (11) Salivary Gland Scintigraphy:

Sodium pertechnetate

### (12) Kidney Scintigraphy:

Technetium dimercaptosuccinate (^{99m}Tc-DMSA), technetium diethylenetriamine-pentaacetate (^{99m}Tc-DTPA), mercaptoacetylglycylglycine technetium (^{99M}Tc-MAG3)

### (13) Spleen Scintigraphy:

Technetium tin colloid, technetium phytate

### (14) Lymph Node Scintigraphy:

Technetium tin colloid, technetium phytate

### (15) Bone Scintigraphy:

Technetium ethanehydroxydiphosphonate (^{99m}Tc-EHDP), technetium hydroxy-methylenediphosphonate (^{99m}Tc-HMDP), technetium pyrophosphate (^{99m}Tc-PYP), technetium methylenephosphonate (^{99m}Tc-MDP)

In the invention as in the above, ¹⁰⁰Mo is irradiated with fast neutron generated by the use of a compact accelerator, not using a nuclear reactor, for producing ⁹⁹Mo. In that manner, a large quantity of radioactive waste is not produced and the radioactivity of the waste may be reduced, as compared with a case of using a nuclear reactor. In addition, in case where ¹⁰⁰Mo in the used radioactive waste from a nuclear reactor is used as a target material nucleus, then not only the production yield of ⁹⁹Mo increases more but also the used radioactive waste from a nuclear reactor can be effectively recycled.

For producing ⁹⁹Mo, usable is a molybdenum oxide powder such as molybdenum trioxide MoO₃ or the like of a natural ¹⁰⁰Mo or one prepared by concentrating ¹⁰⁰Mo to more than the naturally-existing ratio of ¹⁰⁰Mo; or a pellet prepared by compression-molding the powder to have a high density (bulk density of at least 60%) (for example, JP-A 55-22102). In the case where a concentrated ¹⁰⁰Mo is used, it requires pretreatment of electromagnetic separative collection or the like. In the case where a powder of molybdenum trioxide MoO₃ is used, it must be sealed up in a quartz tube and must be further sealed up in an aluminium-based metallic irradiation container. In the case where a pellet formed of a powder of molybdenum trioxide MoO₃ is used, it is directly sealed up in a metallic irradiation container. The metallic irradiation container is the sample container 10. In addition, Mo metal may also be used as the target. In this case, however, Mo extraction requires dissolution in nitric acid or the like. Further, according to the invention, as the Mo target, also usable is a molybdic acid-mixed gel prepared by adding an aqueous molybdic acid solution in which molybdenum is ¹⁰⁰Mo to a titanic acid alkoxide, a zirconic acid alkoxide or their mixture.

⁹⁹Mo produced according to the invention is, after converted into ^{99m}Tc through beta decay, able to be used in medical treatment sites and others; and in this case, ^{99m}Tc may be separated, for example, as follows: An Mo target such as MoO₃ or the like is irradiated with fast neutron, then dissolved in an alkali solution (e.g., sodium hydroxide), and ⁹⁹MoO₄²⁻ is adsorbed by an alumina column, ⁹⁹TcO₄_{^{−}} is taken out by introducing physiological saline into the column, and this is dissolved in a suitable solvent. The operation of extracting the intended ^{99m}Tc is referred to as milking. The milking apparatus is referred to as a generator or a cow. As the generator, also preferred for use herein is a PZC generator in which ⁹⁹Mo is adsorbed by a high-density zirconium compound (PZC) and ^{99m}Tc is extracted by applying a flow of physiological saline thereto (e.g., JP-A 52-17199, 08-309182, 10-30027).

In the invention, as a target material, also usable is a molybdic acid-mixed gel prepared by adding an aqueous molybdic acid solution in which molybdenum is ¹⁰⁰Mo to a titanic acid alkoxide, a zirconic acid alkoxide or their mixture, as so mentioned in the above.

In this case, the alcohol to be used for the titanic acid alkoxide, zirconic acid alkoxide or their mixture includes, for example, monoalcohols such as methanol, ethanol, isopropanol, butanol, etc.; dialcohols such as ethylene glycol, etc.; polyalcohols such as glycerin, polyvinyl alcohol, etc.

For the aqueous molybdic acid solution, usable are ammonium molybdate (NH₄)₂MoO₄, potassium molybdate, calcium molybdate, cobalt molybdate, sodium molybdate, lead molybdate, magnesium molybdate, manganese (II) molybdate, etc.

An example of a method for producing molybdic acid-mixed titanic acid gel is described here.

A molybdic acid-mixed gel is prepared as follows: Titanium(IV) t-butoxide, Ti(O—C₄H₉)₄ (10 ml) and ammonium molybdate (1 mol) are dissolved in n-butanol C₄H₅OH [100 ml), and then, with stirring with a stirrer, 0.1N HNO₃ [10 ml] is added thereto to produce a molybdic acid-containing titanic acid gel through hydrolysis of butyl titanate.

The produced titanic acid gel is collected through centrifugation, then washed with acetone, dried, and thereafter compression-molded to give a sample for irradiation.

In that manner, when a molybdic acid-mixed titanic acid gel is used as the target material, then the operation of mixing ⁹⁹Mo that has been irradiated with fast neutron, into a zirconic acid gel or a titanic acid gel is unnecessary, and therefore, this method is advantageous as free from operators' nuclear exposure and environmental pollution problem in gelling operation.

### Example 2

To confirm the production of RI by irradiating a target material of natural Co with neutron beams from an accelerator to thereby induce (n, 2n) reaction of emitting two neutrons through irradiation with one neutron, natural Co (diameter, about 10 mm; thickness, 1 mm; weight, 727.5 mg) was processed under the same condition as in Example 1 for production of ⁵⁸Co and for measurement of the residual radioactivity (measurement in FNS).

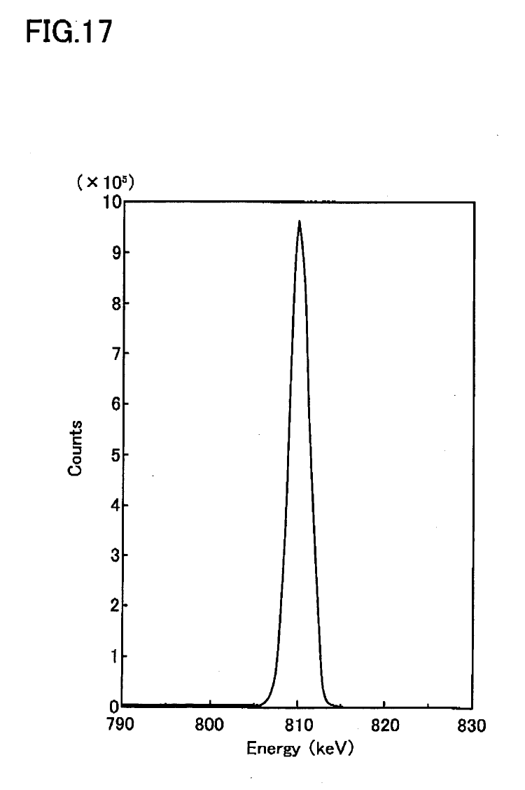

The ⁵⁸Co sample arrangement was also the same as in the above. Using a Ge semiconductor detector, the 811 keV gamma ray emitted in ⁵⁸Co beta decay was detected and measured. The measurement data are shown in FIG. 17. From FIG. 17, it is confirmed that when the above-mentioned target material is irradiated with fast neutron from an accelerator, then RI is produced through (n, 2n) reaction.

### Example 3

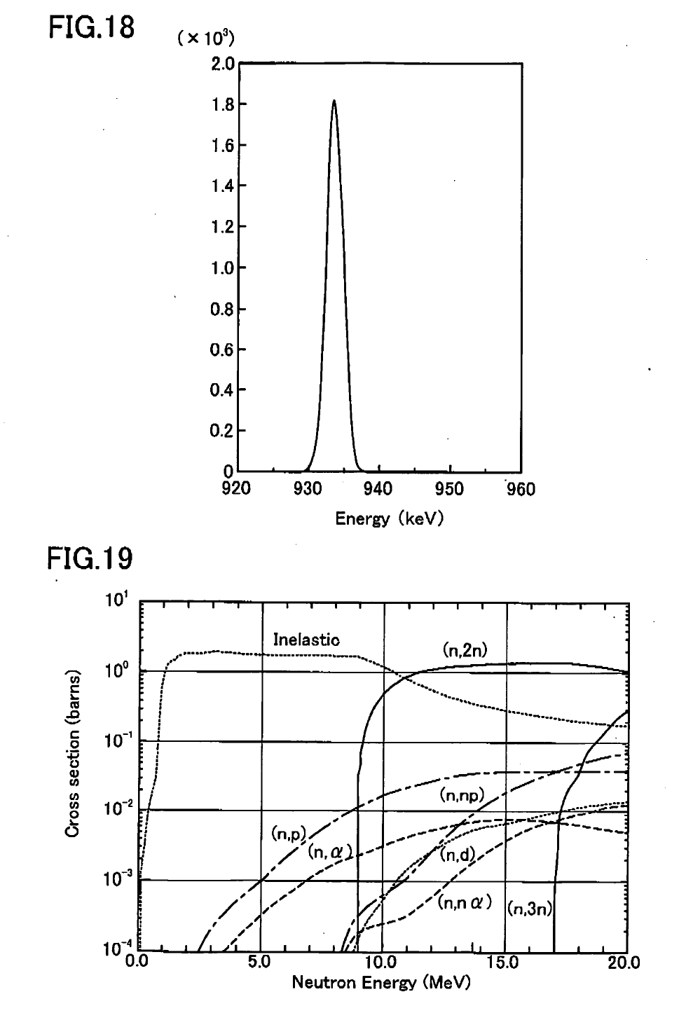

In measurement of the ⁹³Nb target in the above-mentioned Example 1, the 935 keV gamma ray emitted in beta decay of ⁹²Nb was detected. This is for collateral evidence of the formation of RI in (n, 3n) reaction through irradiation of the above-mentioned target material with fast neutron from an accelerator. The results are shown in FIG. 18. FIG. 19 is a view showing the evaluated values of various reactions occurring in irradiation of the ⁹³Nb target with neutron, and the neutron energy dependence of the cross-section areas thereof (from JENDEL-3.3 (versatile evaluated nuclei data library of the Japan Atomic Energy Agency)). From these drawings, it is known that, when ⁹³Nb is irradiated with fast neutron from an accelerator, then the (n, 3n) reaction occurs at around 17 MeV or more.

### Example 4

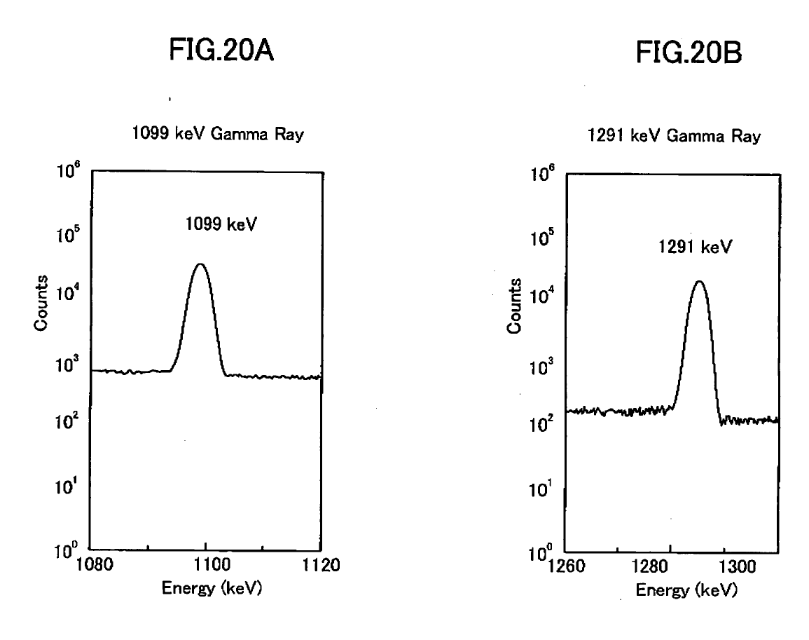

To confirm the production of RI by irradiating a target material with fast neutron beams from an accelerator to thereby induce (n, p) reaction of emitting one proton through irradiation with one neutron, natural Co (diameter, about 10 mm; thickness, 1 mm; weight, 727.5 mg) was processed under the same condition as in Example 1 for production of ⁵⁹Fe and for measurement of the residual radioactivity (measurement in FNS). Using a Ge semiconductor detector, the 1099 keV and 1291 keV gamma rays emitted in ⁵⁹Fe beta decay were detected and measured. The measurement data are shown in FIG. 20. FIGS. 20A and 20B are data of 1099 keV and 1291 keV, respectively. From these drawings, it is known that when the above-mentioned target material is irradiated with fast neutron from an accelerator, then RI is produced through (n, p) reaction.

### Example 5

A target material with a target nucleus of ⁹⁹Tc (ground state of ⁹⁹Tc) was irradiated with fast neutron from an accelerator to induce (n, p) reaction of emitting one proton through irradiation with one neutron, whereby the production of ⁹⁹Mo was confirmed. The method is expected to contribute toward the establishment of a stable supply system for ⁹⁹Mo as a radiopharmaceutical of which stable supply is now much needed.

### Example 6

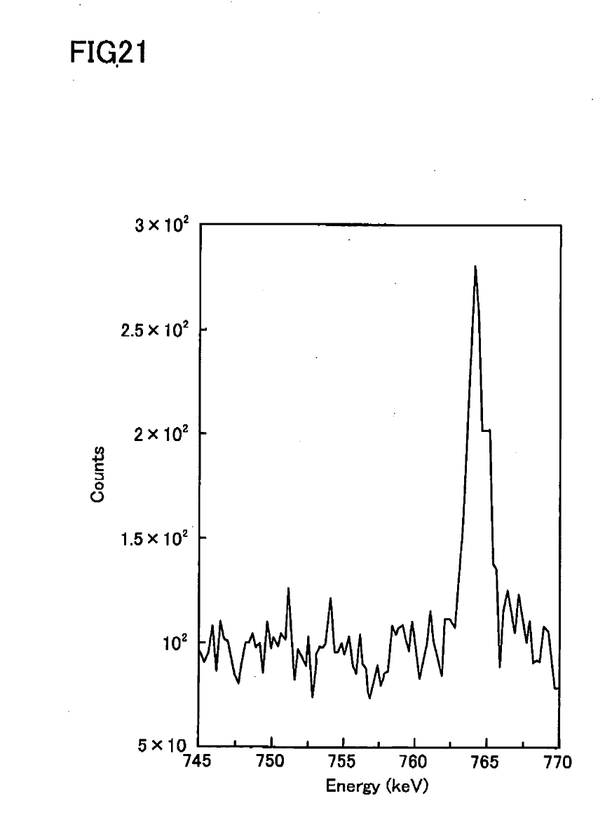

To confirm the production of RI by irradiating a target material with neutron beams from an accelerator to thereby induce (n, np) reaction of emitting one neutron and one proton through irradiation with one neutron, natural RuO (diameter, about 10 mm; weight, 521.4 mg) was processed under the same condition as in Example 1 for production of ⁹⁵Tc and for measurement of the residual radioactivity (measurement in FNS). Using a Ge semiconductor detector, the 766 keV gamma ray emitted in ⁹⁵Tc beta decay was detected and measured. The found data are shown in FIG. 21. The 766 keV gamma ray is a gamma ray emitted in further beta decay of ⁹⁵Tc produced through beta decay in ⁹⁶Ru (n, np) ⁹⁵Tc reaction and ⁹⁶Ru (n, 2n) ⁹⁵Ru reaction. From the above, it is confirmed that ⁹⁵Tc is produced through irradiation with 14 MeV fast neutron.

### Example 7

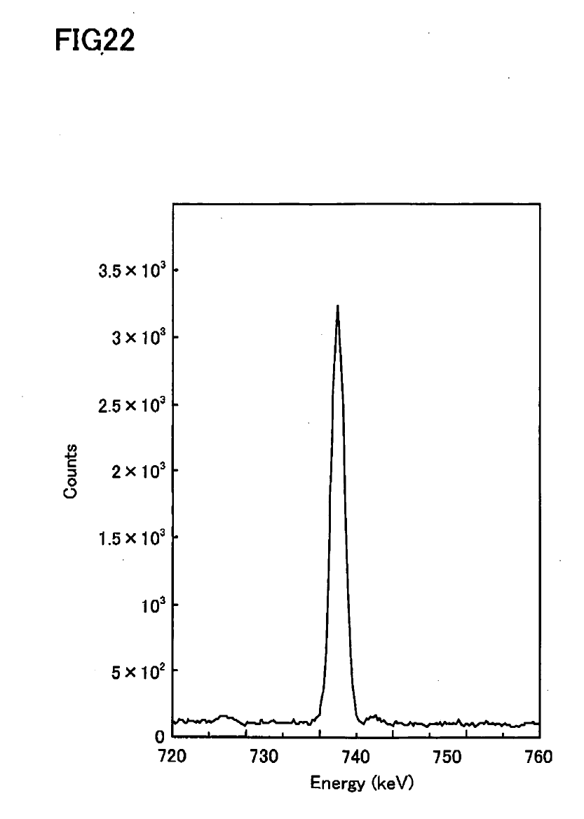

To confirm the production of RI by irradiating a target material with neutron beams from an accelerator to thereby induce (n, ⁴He) reaction of emitting ⁴He through irradiation with one neutron, natural RuO (diameter, about 10 mm; weight, 521.4 mg) was processed under the same condition as in Example 1 for production of ⁹⁹Mo and for measurement of the residual radioactivity (measurement in FNS). Using a Ge semiconductor detector, the 739 keV gamma ray emitted in ⁹⁹Mo beta decay was detected and measured. The found data are shown in FIG. 22. From the above, it is confirmed that ⁹⁹Mo is produced through irradiation with 14 MeV fast neutron.

### Example 8

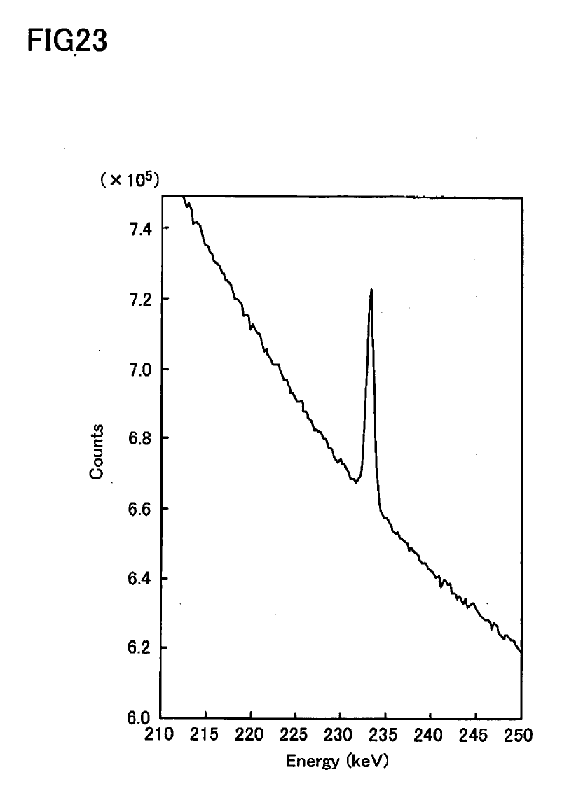

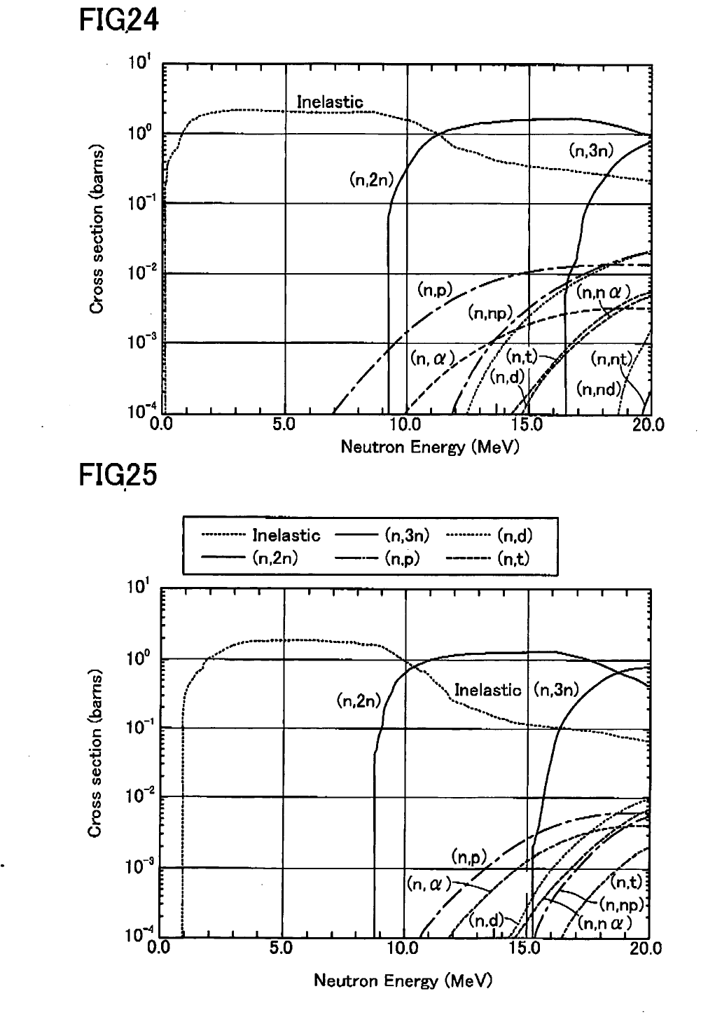

To confirm the production of RI by irradiating a target material with neutron beams from an accelerator to thereby induce (n, p) reaction of emitting one proton through irradiation with one neutron, 4 g of cesium carbonate as a target material was processed in an experiment of producing RI through irradiation with fast neutron from an accelerator under the same condition as in Example 1. This experiment is for collateral evidence of the formation of RI ¹³³Xe through ¹³⁴Xe (n, 2n) ¹³³Xe reaction from a gas target material ¹³⁴Xe. In the experiment, ¹³³Xe was produced and the residual radioactivity was measured (in FNS). Using a Ge semiconductor detector, the 233 keV gamma ray emitted in decay from the 233 keV excitation state of ¹³³Xe to the ground state thereof was detected and measured. The measurement data are shown in FIG. 23. FIG. 24 shows the evaluated scores of the neutron energy dependency of the cross-section area of the (n, p) reaction occurring in irradiation of the ¹³³Cs target with neutron (from JENDEL-3.3). At 14 MeV, it is around 0.01 barn. FIG. 25 shows the evaluated scores of the neutron energy dependency of the cross-section area of the (n, 2n) reaction occurring in irradiation of the ¹³⁴Xe target with neutron (from JENDEL-3.3). At 14 MeV, it is around 1.5 barn.

In the above experiment, data of the cross-section of ¹³³Cs (n, p) ¹³³Xe reaction of around 0.01 barn was obtained. With ¹³⁴Xe, the cross-section of ¹³⁴Xe (n, 2n) ¹³³Xe reaction is around 1.5 barn, and this confirms the ¹³⁴Xe (n, 2n) ¹³³Xe reaction.

### Example 9

Next described is a technique of producing radioactive yttrium for pharmaceutical use that is used in production of radiopharmaceuticals.

As a radioisotope ⁹° Y for use in nuclear medicine, a beta decay product of ⁹⁰Sr that is referred to as ⁹⁰Sr/⁹⁰Y generator is used. ⁹⁰Sr is produced in a large quantity in fission reaction of ²³⁵U in a nuclear reactor, and its half-life is 28.8 years and is long. As shown in FIG. 1, ⁹⁰Sr is in the vicinity of the left-side peak. ⁹⁰Sr has a long half-life period, and therefore based on the nuclear characteristic thereof, ⁹⁰Y is produced and utilized for a long period of time according to a milking method.

On the other hand, ⁹⁰Sr 100% beta-decays to the ground state of ⁹⁰Y; and ⁹° Y has a half-life of 64 hours, and it 100% beta-decays to the ground state of ⁹⁰Zr. It is known that ⁹⁰Y emits beta ray having a maximum energy of 2280 keV.

A radiolabeled therapeutic agent, ibritumomab tiuxetan (trade name Zevalin) was created for cancer therapy with beta rays emitted by ⁹⁰Y; and medical treatment with it is now under way all over the world.

Medical treatment with Zevalin comprises (1) administration of a therapeutic agent for preliminary confirmation of biological distribution and (2) administration of a therapeutic agent for medical treatment through beta ray irradiation; and the two administrations are attained at an interval of about 1 week therebetween.

However, ⁹⁰Y to be produced from ⁹⁰Sr/⁹⁰Y generator emits only a beta ray but does not emit a gamma ray, and therefore, even when a compound labeled with ⁹⁰Y alone is injected to a living body, an image could not be taken for obtaining the information of biological distribution. Accordingly, for the first administration, ¹¹¹In-containing Zevalin is used; and for the second administration, ⁹⁰Y-containing Zevalin yttrium is used. ¹¹¹In has a half-life of 2.8 days, and beta-decayed into ¹¹¹Cd, emitting gamma rays having energy of 171 keV and 245 keV. An image is taken by detecting the gamma rays. ¹¹¹In is produced in a cyclotron. In this connection, these medicines are made-to-order products, and here in Japan, at present, they are extremely expensive, and are 4,300,000 yen per set.

There is a study report saying that the biological behavior in a living body to which a ⁹⁰Y medicine is administered differs from the biological behavior in a living body to which a ¹¹¹In medicine is administered, and as a result, there is a positional difference in the distribution concentration between ⁹⁰Y and ¹¹¹In (Y. Naruki et al., Nucl. Med. Biol, 17, 201 (1990)). The positional difference in the distribution concentration between the two, if any, will be a serious problem as losing the signification of taking a photographic image of the biological distribution with a gamma camera, using a ¹¹¹In medicine.

Accordingly, for taking a photographic image with a ⁹⁰Y medicine alone, a trial is being made of utilizing a braking radiation in release of a beta ray from ⁹⁰Y. However, different from a discontinuous gamma ray, the Bremsstrahlung has a continuous energy distribution and therefore could hardly be differentiated from the Bremsstrahlung by ⁹⁰Y (to be a background) adsorbed by the healthy site except the involved site. Further, the proportion of the Bremsstrahlung emitted by the beta ray is low, and therefore, for obtaining an accurate image, the amount of ⁹⁰Y to be used must be increased. However, this is unfavorable from the viewpoint of nuclear exposure in the normal tissue of a living body.

The radioactive yttrium for medical use produced in this Example is characterized in that it comprises ⁹⁰Y having an excitation energy of 682 keV in addition to ⁹⁰Y in the ground state and that it is used for medicines for both diagnosis and treatment or those specialized for medical diagnosis.

Another radioactive yttrium for medical use produced in this Example is characterized in that it comprises ⁹¹Y having an excitation energy of 556 keV and that it is used for medicines specialized for medical diagnosis.

A type of the radioactive yttrium ⁹⁰Y for medical use produced in this Example has a half-life of 3.2 hours and emits a gamma ray having an energy of 202 keV and 480 keV when being into the ground state from the excitation state thereof. ⁹⁰Y in the ground state has a half-life of 64 hours, and it 100% beta-decays into ⁹⁰Zr of the ground state, while emitting a beta ray of at most 2280 keV. Accordingly, when the radioactive yttrium ⁹⁰Y for medical use produced in this Example is used in production of medicines, then the information of biological distribution of the medicine can be accurately taken by counting the gamma ray emitted by ⁹⁰Y when it changes from the excitation state to the ground state, with a gamma camera; and in addition, the beta ray to be released in beta decay of ⁹⁰Y in the ground state to ⁹⁰Zr in the ground state may be used for medical treatment; and therefore, the diagnosis and the medical treatment with administration of a medicine containing two types of RIs can be attained by administration of a medicine containing one type of RI. The radioactive yttrium for medical use of the invention can be used as those specialized for diagnosis alone in case where there already exists a large quantity of ⁹⁰Y for medical treatment to be produced from ⁹⁰Sr/⁹⁰Y generator and ⁹⁰Y of the type is readily available. The same shall apply also to ⁹¹Y.

The radioactive yttrium ⁹⁰Y for medical use produced in this Example may be effectively used for diagnosis or medical treatment, or for diagnosis alone; and ⁹¹Y may be effectively used for diagnosis alone, or for radioactive labeling of protein, for example, antibody. Specifically, ⁹⁰Y or ⁹¹Y in an excitation state can be radiolabeled as a gamma emitter for visualizing tumor; and ⁹⁰Y in the ground state can be radiolabeled as a beta emitter for killing cells.

Radiolabeling with ⁹⁰Y or ⁹¹Y may be attained according to various conventional known methods. For example, in radiolabeling of antibody or peptide, a bound body of a bifunctional chelator and a protein or antibody is constructed, and then the bound body is further bound to a radiolabeling ⁹⁰Y or ⁹¹Y of the invention via the bifunctional chelator thereof. For example, as described in JP-T 2002-538164 and 2006-511532, diethylenetriamine-pentaacetic acid chelator (DTPA), MX-DTPA, phenyl-DTPA, benzyl-DTPA, NOTA, TETA, DOTA or the like as a bifunctional chelator can be used.

Needless-to-say, for the method of radiolabeling, any well known methods may be referred to.

The radioactive yttrium ⁹⁰Y or ⁹¹Y for medical use in this Example can be produced according to the following methods, neither using concentrated uranium nor using a nuclear reactor facility, but using fast neutron from an accelerator.

(A) A target material containing concentrated ⁹⁰Zr or ⁹⁰Zr is irradiated with fast neutron from an accelerator to induce (n, p) reaction of emitting one proton through irradiation with one neutron, thereby producing radioactive yttrium for medical use that comprises ⁹⁰Y having an excitation energy of 682 keV in addition to ⁹⁰Y in the ground state.

(B) A target material containing concentrated ⁹¹Zr or ⁹¹Zr is irradiated with fast neutron from an accelerator to induce (n, np) reaction of emitting one neutron and one proton through irradiation with one neutron, thereby producing radioactive yttrium for medical use that comprises ⁹⁰Y having an excitation energy of 682 keV in addition to ⁹⁰Y in the ground state.

(C) A target material containing ⁹³Nb is irradiated with fast neutron from an accelerator to induce (n, ⁴He) reaction of emitting one ⁴He through irradiation with one neutron, thereby producing radioactive yttrium for medical use that comprises ⁹⁰Y having an excitation energy of 682 keV in addition to ⁹⁰Y in the ground state.

(D) A target material containing concentrated ⁹¹Zr or ⁹¹Zr is irradiated with fast neutron from an accelerator to induce (n, p) reaction of emitting one proton through irradiation with one neutron, thereby producing radioactive yttrium for medical use that comprises ⁹¹Y having an excitation energy of 556 keV.

(E) A target material containing concentrated ⁹²Zr or ⁹²Zr is irradiated with fast neutron from an accelerator to induce (n, np) reaction of emitting one neutron and one proton through irradiation with one neutron, thereby producing radioactive yttrium for medical use that comprises ⁹¹Y having an excitation energy of 556 keV.

Yttrium isotope containing ⁹⁰Y and ⁹¹Y is produced from a Zr target at an energy of at least 6 MeV, and from an Nb target at an energy of at least 3 MeV. However, the ground state yield of ⁹¹Y that has a longer half-life period is preferably smaller than the ground state yield of ⁹⁰Y, and therefore, in case where a concentrated Zr target is irradiated for 64 hours, the energy is preferably from 3.5 MeV to 20 MeV or so; in case where a non-concentrated Zr target is irradiated, the energy is preferably from 3.5 MeV to 15 MeV or so; and in case where an Nb target is irradiated for 64 hours, the energy is preferably from 3 MeV to 17 MeV or so.

Regarding the target material for use in this Example, for example, the Zr target is preferably zirconium oxide (ZrO₂) or zirconium tetrachloride (ZrCl₄); and the Nb target is preferably niobium monoxide (NbO), niobium pentoxide (Nb₂O₅) or niobium pentachloride (NbCl₅).

1. A method for producing a radioisotope by irradiating a target material with fast neutrons from an accelerator.

2. The method for producing a radioisotope as claimed in claim 1, wherein a target material is irradiated with fast neutrons from an accelerator to produce a radioisotope by emitting non-charged particles.

3. The method for producing a radioisotope as claimed in claim 2, wherein any of the following reactions is used to produce a radioisotope;
(1) (n, 2n) reaction: two-neutron pickup reaction induced by neutrons,
(2) (n, 3n) reaction: three-neutron pickup reaction induced by neutrons,
(3) (n, n′) reaction: neutron inelastic scattering reaction.

4. The method for producing a radioisotope as claimed in claim 3, wherein one or several targets listed in Table 1 to Table 8 can be used to produce a radioisotope by the (n, 2n) reaction.

5. The method for producing a radioisotope as claimed in claim 3, wherein one or several targets listed in Table 9 can be used to produce a radioisotope by the (n, 3n) reaction.

6. The method for producing a radioisotope as claimed in claim 3, wherein one or several targets listed in Table 10 and Table 11 can be used to produce a radioisotope by the (n, n′) reaction.

7. The method for producing a radioisotope as claimed in claim 1, wherein a target material is irradiated with fast neutrons from an accelerator to produce a radioisotope by emitting charged particles or charged particles and non-charged particles.

8. The method for producing a radioisotope as claimed in claim 7, wherein any of the following reactions is used to produce a radioisotope:
(1) (n, p) reaction: one proton-pickup reaction induced by neutrons,
(2) (n, np) reaction: one neutron- and one proton-pickup reaction induced by neutrons,
(3) (n, ⁴He) reaction: one ⁴He-pickup reaction induced by neutrons.

9. The method for producing a radioisotope as claimed in claim 8, wherein one or several targets listed in Table 12 to Table 18 can be used to produce a radioisotope by the (n, p) reaction.

10. The method for producing a radioisotope as claimed in claim 8, wherein one or several targets listed in Table 19 and Table 20 can be used to produce a radioisotope by the (n, np) reaction.

11. The method for producing a radioisotope as claimed in claim 8, wherein one or several targets listed in Table 21 can be used to produce a radioisotope by the (n, ⁴He) reaction.

12. The method for producing a radioisotope as claimed in claim 1, wherein a target material is set either very close or near to the fast neutron production position.

13. An apparatus for producing a radioisotope, comprising:
an accelerator for producing fast neutrons, and
a target support;
wherein a target material is irradiated with fast neutrons from an accelerator to produce a radioisotope.

14. The apparatus for producing a radioisotope as claimed in claim 13, wherein a target material is irradiated with fast neutrons from an accelerator to produce a radioisotope by emitting non-charged particles.

15. The apparatus for producing a radioisotope as claimed in claim 14, wherein any of the following reactions is used to produce a radioisotope:
(1) (n, 2n) reaction: two-neutron pickup reaction induced by neutrons,
(2) (n, 3n) reaction: three-neutron pickup reaction induced by neutrons,
(3) (n, n′) reaction: neutron inelastic scattering reaction.

16. The apparatus for producing a radioisotope as claimed in claim 15, wherein one or several targets listed in Table 1 to Table 8 can be used to produce a radioisotope by the (n, 2n) reaction.

17. The apparatus for producing a radioisotope as claimed in claim 15, wherein one or several targets listed in Table 9 can be used to produce a radioisotope by the (n,3n) reaction.

18. The apparatus for producing a radioisotope as claimed in claim 15, wherein one or several targets listed in Table 10 and Table 11 can be used to produce a radioisotope by the (n, n′) reaction.

19. The apparatus for producing a radioisotope as claimed in claim 13, wherein a target material is irradiated with fast neutrons from an accelerator to produce a radioisotope by simultaneously emitting charged particles or charged particles and non-charged particles.

20. The apparatus for producing a radioisotope as claimed in claim 19, wherein any of the following reactions is used to produce a radioisotope:
(1) (n, p) reaction: one proton-pickup reaction induced by neutrons,
(2) (n, np) reaction: one neutron- and one proton-pickup reaction induced by neutrons,
(3) (n, ⁴He) reaction: one ⁴He-pickup reaction induced by neutrons.

21. The apparatus for producing a radioisotope as claimed in claim 20, wherein one or several targets listed in Table 12 to Table 18 can be used to produce a radioisotope by the (n, p) reaction.

22. The apparatus for producing a radioisotope as claimed in claim 20, wherein one and/or several targets listed in Table 19 and Table 20 can be used to produce a radioisotope by the (n, np) reaction.

23. The apparatus for producing a radioisotope as claimed in claim 20, wherein one or several targets listed in Table 21 can be used to produce a radioisotope by the (n, ⁴He) reaction.

24. The apparatus for producing a radioisotope as claimed in claim 13, wherein a target material is set either very close or near the fast neutron production position.

25. The apparatus for producing a radioisotope as claimed in claim 13, wherein fast neutrons are produced in a vacuum chamber and the fast neutron production place can be cooled by using any coolant, and a target material is set either very close or near to the fast neutron production position.
